(19) United States
(12) Patent Application Publication
(10) Pub. No.: US 2012/0064919 A1
(43) Pub. Date: Mar. 15, 2012

(54) CROWD CREATION SYSTEM FOR AN AGGREGATE PROFILING SERVICE

(75) Inventor: Sean T. Purdy, Durham, NC (US)

(73) Assignee: Waldeck Technology, LLC, Wilmington, DE (US)

(21) Appl. No.: 12/859,837

(22) Filed: Aug. 20, 2010

Related U.S. Application Data
(60) Provisional application No. 61/236,296, filed on Aug. 24, 2009.

(51) Int. Cl. H04W 64/00

(52) U.S. Cl. 455/456.3

(57) ABSTRACT

Systems and methods for creating new crowds of users are disclosed. In one embodiment, a number of geographically relevant Points of Interest (POIs) within a geographic bounding region in which the new crowd is to be created are identified. A POI for the new crowd is then selected from the geographically relevant POIs based on a crowd profile defined for the new crowd. Users to attract to the new crowd at the POI selected for the new crowd are selected based on the crowd profile defined for the new crowd, and the selected users are then attracted to the new crowd at the POI selected for the new crowd.

### RELATED APPLICATIONS

This application claims the benefit of provisional patent application Ser. No. 61/236,296, filed Aug. 24, 2009, the disclosure of which is hereby incorporated herein by reference in its entirety.

### FIELD OF THE DISCLOSURE

The present disclosure relates to crowd formation and more specifically relates to identifying a location for a new crowd of users, selecting users to attract to the new crowd at the location, and attracting the users to the new crowd at the location.

### BACKGROUND

Location-Based Services (LBSs) are becoming prolific as a result of mobile smartphone devices such as, for example, the Apple® iPhone and smartphones utilizing the Google® Android mobile operating system. One such LBS is described in U.S. patent application Ser. No. 12/645,532, entitled FORMING CROWDS AND PROVIDING ACCESS TO CROWD DATA IN A MOBILE ENVIRONMENT, which was filed Dec. 23, 2009; U.S. patent application Ser. No. 12/645,539, entitled ANONYMOUS CROWD TRACKING, which was filed Dec. 23, 2009; U.S. patent application Ser. No. 12/645,535, entitled MAINTAINING A HISTORICAL RECORD OF ANONYMIZED USER PROFILE DATA BY LOCATION FOR USERS IN A MOBILE ENVIRONMENT, which was filed Dec. 23, 2009; U.S. patent application Ser. No. 12/645,546, entitled CROWD FORMATION FOR MOBILE DEVICE USERS, which was filed Dec. 23, 2009; U.S. patent application Ser. No. 12/645,556, entitled SERVING A REQUEST FOR DATA FROM A HISTORICAL RECORD OF ANONYMIZED USER PROFILE DATA IN A MOBILE ENVIRONMENT, which was filed Dec. 23, 2009; U.S. patent application Ser. No. 12/645,560, entitled HANDLING CROWD REQUESTS FOR LARGE GEOGRAPHIC AREAS, which was filed Dec. 23, 2009; and U.S. patent application Ser. No. 12/645,544, entitled MODIFYING A USER'S CONTRIBUTION TO AN AGGREGATE PROFILE BASED ON TIME BETWEEN LOCATION UPDATES AND EXTERNAL EVENTS, which was filed Dec. 23, 2009; all of which are commonly owned and assigned and are hereby incorporated herein by reference in their entireties. One feature provided by this LBS is analyzing the current locations of users in order to form or identify existing crowds of users and determining aggregate profile data for those crowds. The locations of the crowds and the aggregate profiles of the crowds may then be presented to users of the LBS. However, in some situations, a user may wish to participate in a crowd, but there may be no crowds of interest to the user. As such, there is a need for a system and method that enables the creation of a new crowd having desired characteristics.

### SUMMARY

Systems and methods for creating new crowds of users are disclosed. In one embodiment, a number of geographically relevant Points of Interest (POIs) within a geographic bounding region in which the new crowd is to be created are identified. A POI for the new crowd is then selected from the geographically relevant POIs based on a crowd profile defined for the new crowd. Users to attract to the new crowd at the POI selected for the new crowd are selected based on the crowd profile defined for the new crowd, and the selected users are then attracted to the new crowd at the POI selected for the new crowd.

In one embodiment, the POI for the new crowd is selected by first identifying one or more potential POIs for the new crowd from the geographically relevant POIs based on a comparison of the crowd profile defined for the new crowd and profile data for the geographically relevant POIs. User input is then received that selects the POI for the new crowd from the one or more potential POIs identified for the new crowd. In another embodiment, the POI for the new crowd is automatically selected based on a comparison of the crowd profile defined for the new crowd and the profile data for the geographically relevant POIs. For each geographically relevant POI, the profile data for the geographically relevant POI includes user profiles of users currently located at the geographically relevant POI, user profiles of users currently located near the geographically relevant POI, user profiles of users predicted to be located at the geographically relevant POI during a relevant time window defined for the new crowd, user profiles of users predicted to be located near the geographically relevant POI during the relevant time window defined for the new crowd, aggregate profiles of crowds of users currently located at the geographically relevant POI, aggregate profiles of crowds of users currently located near the geographically relevant POI, aggregate profiles of crowds of users predicted to be located at the geographically relevant POI during a relevant time window defined for the new crowd, aggregate profiles of crowds of users predicted to be located near the geographically relevant POI during the relevant time window defined for the new crowd, and/or historical aggregate profile data for the geographically relevant POI.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a Mobile Aggregate Profile (MAP) system according to one embodiment of the present disclosure;

FIG. 2 is a block diagram of the MAP server of FIG. 1 according to one embodiment of the present disclosure;

FIG. 3 is a block diagram of the MAP client of one of the mobile devices of FIG. 1 according to one embodiment of the present disclosure;

FIG. 4 illustrates the operation of the system of FIG. 1 to provide user profiles and current locations of the users of the mobile devices to the MAP server according to one embodiment of the present disclosure;

FIG. 5 illustrates the operation of the system of FIG. 1 to provide user profiles and current locations of the users of the mobile devices to the MAP server according to another embodiment of the present disclosure;

FIGS. 6 and 7 graphically illustrate bucketization of users according to location for purposes of maintaining a historical record of anonymized user profile data by location according to one embodiment of the present disclosure;

FIG. 8 is a flow chart illustrating the operation of a foreground bucketization process performed by the MAP server to maintain the lists of users for location buckets for purposes of maintaining a historical record of anonymized user profile data by location according to one embodiment of the present disclosure;

FIG. 9 is a flow chart illustrating the anonymization and storage process performed by the MAP server for the location buckets in order to maintain a historical record of anonymized user profile data by location according to one embodiment of the present disclosure;

FIG. 10 graphically illustrates anonymization of a user record according to one embodiment of the present disclosure;

FIG. 11 is a flow chart for a quadtree based storage process that may be used to store anonymized user profile data for location buckets according to one embodiment of the present disclosure;

FIG. 12 is a flow chart illustrating a quadtree algorithm that may be used to process the location buckets for storage of the anonymized user profile data according to one embodiment of the present disclosure;

FIGS. 13A through 13E graphically illustrate the process of FIG. 12 for the generation of a quadtree data structure for one exemplary base quadtree region;

FIG. 14 is a flow chart for a spatial crowd formation process according to one embodiment of the present disclosure;

FIGS. 15A through 15D graphically illustrate the crowd formation process of FIG. 14 for an exemplary bounding box;

FIGS. 16A through 16D illustrate a flow chart for a spatial crowd formation process according to another embodiment of the present disclosure;

FIGS. 17A through 17D graphically illustrate the crowd formation process of FIGS. 16A through 16D for a scenario where the crowd formation process is triggered by a location update for a user having no old location;

FIGS. 18A through 18F graphically illustrate the crowd formation process of FIGS. 16A through 16D for a scenario where the new and old bounding boxes overlap;

FIGS. 19A through 19E graphically illustrate the crowd formation process of FIGS. 16A through 16D in a scenario where the new and old bounding boxes do not overlap;

FIG. 20 illustrates a process for creating a new crowd according to one embodiment of the present disclosure;

FIG. 21 illustrates the operation of the system of FIG. 1 to create a new crowd according to one embodiment of the present disclosure;

FIG. 22 illustrates a process for identifying one or more potential Points of Interest (POIs) for a new crowd according to one embodiment of the present disclosure;

FIG. 23 illustrates the operation of the system of FIG. 1 to create a new crowd according to another embodiment of the present disclosure;

FIG. 24 illustrates a process for automatically and programmatically selecting a POI for a new crowd according to one embodiment of the present disclosure;

FIG. 25 is a block diagram of the MAP server of FIG. 1 according to one embodiment of the present disclosure;

FIG. 26 is a block diagram of one of the mobile devices of FIG. 1 according to one embodiment of the present disclosure;

FIG. 27 is a block diagram of the subscriber device of FIG. 1 according to one embodiment of the present disclosure; and

FIG. 28 is a block diagram of a computing device operating to host the third-party service of FIG. 1 according to one embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

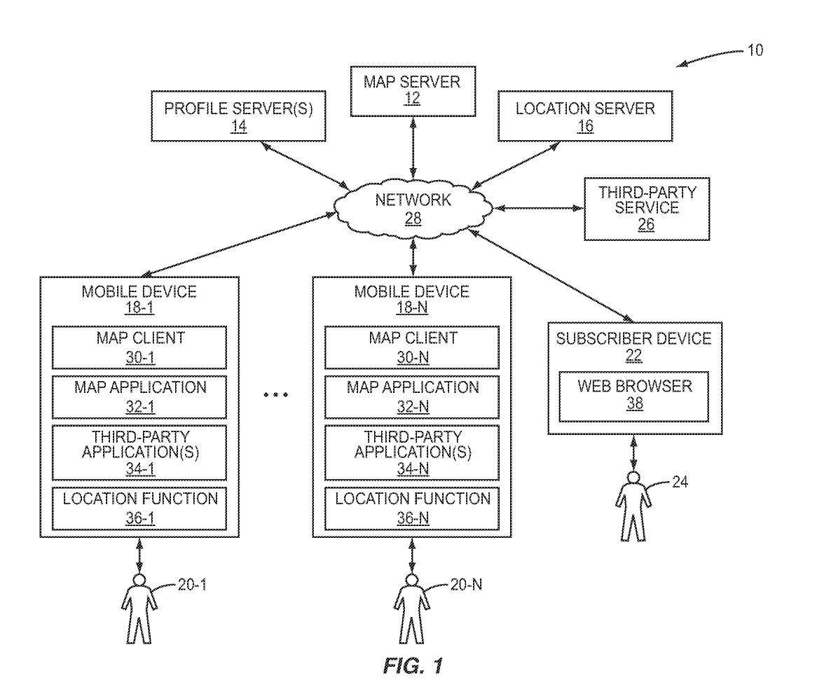

FIG. 1 illustrates a Mobile Aggregate Profile (MAP) system 10 according to one embodiment of the present disclosure. In this embodiment, the system 10 includes a MAP server 12, one or more profile servers 14, a location server 16, a number of mobile devices 18-1 through 18-N having associated users 20-1 through 20-N, a subscriber device 22 having an associated subscriber 24, and a third-party service 26 communicatively coupled via a network 28. The mobile devices 18-1 through 18-N are also generally referred to herein as mobile devices 18, and an individual one of mobile devices 18-1 through 18-N is also generally referred to herein as a mobile device 18. Likewise, the users 20-1 through 20-N are also generally referred to herein as users 20, and an individual one of the users 20-1 through 20-N is also generally referred to herein as a user 20. The network 28 may be any type of network or any combination of networks. Specifically, the network 28 may include wired components, wireless components, or both wired and wireless components. In one exemplary embodiment, the network 28 is a distributed public network such as the Internet, where the mobile devices 18 are enabled to connect to the network 28 via local wireless connections (e.g., WiFi or IEEE 802.11 connections) or wireless telecommunications connections (e.g., 3G or 4G telecommunications connections such as GSM, LTE, W-CDMA, or WiMAX connections).

As discussed below in detail, the MAP server 12 operates to obtain current locations, including location updates, and user profiles of the users 20 of the mobile devices 18. The current locations of the users 20 can be expressed as positional geographic coordinates such as latitude-longitude pairs, and a height vector (if applicable), or any other similar information capable of identifying a given physical point in space in a two-dimensional or three-dimensional coordinate system. Using the current locations and user profiles of the users 20, the MAP server 12 is enabled to provide a number of features such as, but not limited to, maintaining a historical record of anonymized user profile data by location, generating aggregate profile data over time for a Point of Interest (POI) or Area of Interest (AOI) using the historical record of anonymized user profile data, identifying crowds of users using current locations and/or user profiles of the users 20, generating aggregate profiles for crowds of users, tracking crowds, and creating new crowds. Note that while the MAP server 12 is illustrated as a single server for simplicity and ease of discussion, it should be appreciated that the MAP server 12 may be implemented as a single physical server or multiple physical servers operating in a collaborative manner for purposes of redundancy and/or load sharing.

In general, the one or more profile servers 14 operate to store user profiles for a number of persons including the users 20 of the mobile devices 18. For example, the one or more profile servers 14 may be servers providing social network services such as the Facebook® social networking service, the MySpace® social networking service, the LinkedIN® social networking service, or the like. As discussed below, using the one or more profile servers 14, the MAP server 12 is enabled to directly or indirectly obtain the user profiles of the users 20 of the mobile devices 18. The location server 16 generally operates to receive location updates from the mobile devices 18 and make the location updates available to entities such as, for instance, the MAP server 12. In one exemplary embodiment, the location server 16 is a server operating to provide Yahoo!'s FireEagle service.

The mobile devices 18 may be mobile smart phones, portable media player devices, mobile gaming devices, or the like. Some exemplary mobile devices that may be programmed or otherwise configured to operate as the mobile devices 18 are the Apple® iPhone, the Palm Pre®, the Samsung Rogue™, the Blackberry Storm™, the Motorola Droid or similar phone running Google's Android™ Operating System, an Apple® iPad, and the Apple® iPod Touch® device. However, this list of exemplary mobile devices is not exhaustive and is not intended to limit the scope of the present disclosure.

The mobile devices 18-1 through 18-N include MAP clients 30-1 through 30-N (generally referred to herein as MAP clients 30 or individually as MAP client 30), MAP applications 32-1 through 32-N (generally referred to herein as MAP applications 32 or individually as MAP application 32), third-party applications 34-1 through 34-N (generally referred to herein as third-party applications 34 or individually as third-party application 34), and location functions 36-1 through 36-N (generally referred to herein as location functions 36 or individually as location function 36), respectively. The MAP client 30 is preferably implemented in software. In general, in the preferred embodiment, the MAP client 30 is a middleware layer operating to interface an application layer (i.e., the MAP application 32 and the third-party applications 34) to the MAP server 12. More specifically, the MAP client 30 enables the MAP application 32 and the third-party applications 34 to request and receive data from the MAP server 12. In addition, the MAP client 30 enables applications, such as the MAP application 32 and the third-party applications 34, to access data from the MAP server 12.

The MAP application 32 is also preferably implemented in software. The MAP application 32 generally provides a user interface component between the user 20 and the MAP server 12. More specifically, among other things, the MAP application 32 enables the user 20 to initiate requests for historical aggregate profile data and/or crowd data from the MAP server 12 and presents corresponding data returned by the MAP server 12 to the user 20. In one embodiment, the MAP application 32 enables the user 20 to initiate a process for creating a new crowd, as described below in detail. The MAP application 32 also enables the user 20 to configure various settings. For example, the MAP application 32 may enable the user 20 to select a desired social networking service (e.g., Facebook®, MySpace®, LinkedlN®, etc.) from which to obtain the user profile of the user 20 and provide any necessary credentials (e.g., username and password) needed to access the user profile from the social networking service.

The third-party applications 34 are preferably implemented in software. The third-party applications 34 operate to access the MAP server 12 via the MAP client 30. The third-party applications 34 may utilize data obtained from the MAP server 12 in any desired manner. As an example, one of the third-party applications 34 may be a gaming application that utilizes crowd data to notify the user 20 of POIs or AOIs where crowds of interest are currently located. It should be noted that while the MAP client 30 is illustrated as being separate from the MAP application 32 and the third-party applications 34, the present disclosure is not limited thereto. The functionality of the MAP client 30 may alternatively be incorporated into the MAP application 32 and the third-party applications 34.

The location function 36 may be implemented in hardware, software, or a combination thereof. In general, the location function 36 operates to determine or otherwise obtain the location of the mobile device 18. For example, the location function 36 may be or include a Global Positioning System (GPS) receiver.

The subscriber device 22 is a physical device such as a personal computer, a mobile computer (e.g., a notebook computer, a netbook computer, a tablet computer, etc.), a mobile smart phone, or the like. The subscriber 24 associated with the subscriber device 22 is a person or entity. In general, the subscriber device 22 enables the subscriber 24 to access the MAP server 12 via a web browser 38 to obtain various types of data, preferably for a fee. For example, the subscriber 24 may pay a fee to have access to crowd data such as aggregate profiles for crowds located at one or more POIs and/or located in one or more AOIs, pay a fee to track crowds, or the like. Note that the web browser 38 is exemplary. In another embodiment, the subscriber device 22 is enabled to access the MAP server 12 via a custom application.

Lastly, the third-party service 26 is a service that has access to data from the MAP server 12 such as aggregate profiles for one or more crowds at one or more POIs or within one or more AOIs. Based on the data from the MAP server 12, the third-party service 26 operates to provide a service such as, for example, targeted advertising. For example, the third-party service 26 may obtain anonymous aggregate profile data for one or more crowds located at a POI and then provide targeted advertising to known users located at the POI based on the anonymous aggregate profile data. Note that while targeted advertising is mentioned as an exemplary third-party service 26, other types of third-party services 26 may additionally or alternatively be provided. Other types of third-party services 26 that may be provided will be apparent to one of ordinary skill in the art upon reading this disclosure.

Before proceeding, it should be noted that while the system 10 of FIG. 1 illustrates an embodiment where the one or more profile servers 14 and the location server 16 are separate from the MAP server 12, the present disclosure is not limited thereto. In an alternative embodiment, the functionality of the one or more profile servers 14 and/or the location server 16 may be implemented within the MAP server 12.

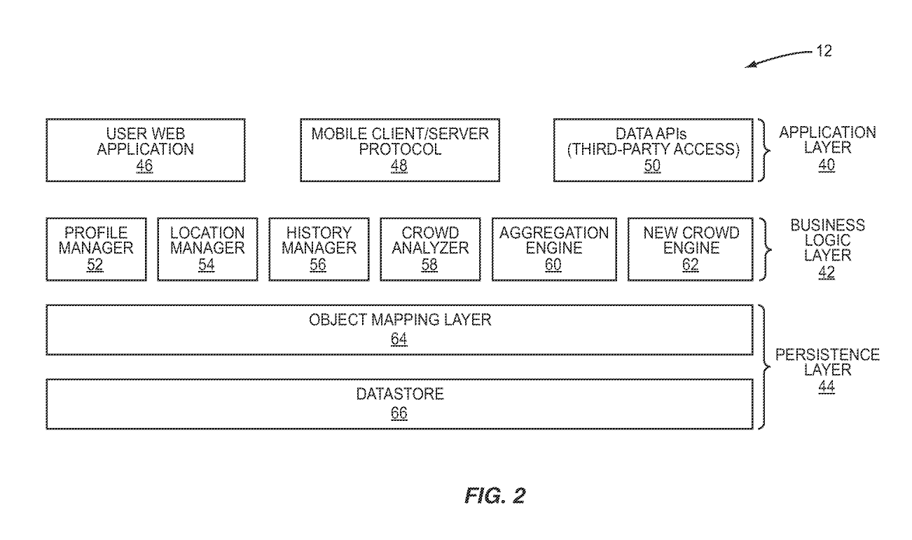

FIG. 2 is a block diagram of the MAP server 12 of FIG. 1 according to one embodiment of the present disclosure. As illustrated, the MAP server 12 includes an application layer 40, a business logic layer 42, and a persistence layer 44. The application layer 40 includes a user web application 46, a mobile client/server protocol component 48, and one or more data Application Programming Interfaces (APIs) 50. The user web application 46 is preferably implemented in software and operates to provide a web interface for users, such as the subscriber 24, to access the MAP server 12 via a web browser. The mobile client/server protocol component 48 is preferably implemented in software and operates to provide an interface between the MAP server 12 and the MAP clients 30 hosted by the mobile devices 18. The data APIs 50 enable third-party services, such as the third-party service 26, to access the MAP server 12.

The business logic layer 42 includes a profile manager 52, a location manager 54, a history manager 56, a crowd analyzer 58, an aggregation engine 60, and a new crowd engine 62, each of which is preferably implemented in software. The profile manager 52 generally operates to obtain the user profiles of the users 20 directly or indirectly from the one or more profile servers 14 and store the user profiles in the persistence layer 44. The location manager 54 operates to obtain the current locations of the users 20 including location updates. As discussed below, the current locations of the users 20 may be obtained directly from the mobile devices 18 and/or obtained from the location server 16.

The history manager 56 generally operates to maintain a historical record of anonymized user profile data by location. Note that while the user profile data stored in the historical record is preferably anonymized, it is not limited thereto. The crowd analyzer 58 operates to form crowds of users. In one embodiment, the crowd analyzer 58 utilizes a spatial crowd formation algorithm. However, the present disclosure is not limited thereto. In addition, the crowd analyzer 58 may further characterize crowds to reflect degree of fragmentation, best-case and worst-case degree of separation (DOS), and/or degree of bi-directionality. Still further, the crowd analyzer 58 may also operate to track crowds. The aggregation engine 60 generally operates to provide aggregate profile data in response to requests from the mobile devices 18, the subscriber device 22, and the third-party service 26. The aggregate profile data may be historical aggregate profile data for one or more POIs or one or more AOIs or aggregate profile data for crowd(s) currently at one or more POIs or within one or more AOIs. For additional information regarding the operation of the profile manager 52, the location manager 54, the history manager 56, the crowd analyzer 58, and the aggregation engine 60, the interested reader is directed to U.S. patent application Ser. No. 12/645,532, entitled FORMING CROWDS AND PROVIDING ACCESS TO CROWD DATA IN A MOBILE ENVIRONMENT, which was filed Dec. 23, 2009; U.S. patent application Ser. No. 12/645,539, entitled ANONYMOUS CROWD TRACKING, which was filed Dec. 23, 2009; U.S. patent application Ser. No. 12/645,535, entitled MAINTAINING A HISTORICAL RECORD OF ANONYMIZED USER PROFILE DATA BY LOCATION FOR USERS IN A MOBILE ENVIRONMENT, which was filed Dec. 23, 2009; U.S. patent application Ser. No. 12/645,546, entitled CROWD FORMATION FOR MOBILE DEVICE USERS, which was filed Dec. 23, 2009; U.S. patent application Ser. No. 12/645,556, entitled SERVING A REQUEST FOR DATA FROM A HISTORICAL RECORD OF ANONYMIZED USER PROFILE DATA IN A MOBILE ENVIRONMENT, which was filed Dec. 23, 2009; U.S. patent application Ser. No. 12/645,560, entitled HANDLING CROWD REQUESTS FOR LARGE GEOGRAPHIC AREAS, which was filed Dec. 23, 2009; and U.S. patent application Ser. No. 12/645,544, entitled MODIFYING A USER'S CONTRIBUTION TO AN AGGREGATE PROFILE BASED ON TIME BETWEEN LOCATION UPDATES AND EXTERNAL EVENTS, which was filed Dec. 23, 2009; all of which are hereby incorporated herein by reference in their entireties.

As described below in detail, the new crowd engine 62 of the MAP server 12 operates to create new crowds of users. Specifically, the new crowd engine 62 selects a POI at which to form a new crowd. In one embodiment, the selected location is preferably selected based on a comparison of a crowd profile defined for the new crowd and historical data for the selected POI and/or crowd data for crowds of users currently located at, and in some embodiments near, the selected POI. The new crowd engine 62 then selects users to attract to the new crowd at the selected POI and attracts the selected users to the new crowd at the selected POI via, for example, sending an appropriate message to the mobile devices 18 of the selected users.

The persistence layer 44 includes an object mapping layer 64 and a datastore 66. The object mapping layer 64 is preferably implemented in software. The datastore 66 is preferably a relational database, which is implemented in a combination of hardware (i.e., physical data storage hardware) and software (i.e., relational database software). In this embodiment, the business logic layer 42 is implemented in an object-oriented programming language such as, for example, Java. As such, the object mapping layer 64 operates to map objects used in the business logic layer 42 to relational database entities stored in the datastore 66. Note that, in one embodiment, data is stored in the datastore 66 in a Resource Description Framework (RDF) compatible format.

In an alternative embodiment, rather than being a relational database, the datastore 66 may be implemented as an RDF datastore. More specifically, the RDF datastore may be compatible with RDF technology adopted by Semantic Web activities. Namely, the RDF datastore may use the Friend-Of-A-Friend (FOAF) vocabulary for describing people, their social networks, and their interests. In this embodiment, the MAP server 12 may be designed to accept raw FOAF files describing persons, their friends, and their interests. These FOAF files are currently output by some social networking services such as Livejournal and Facebook®. The MAP server 12 may then persist RDF descriptions of the users 20 as a proprietary extension of the FOAF vocabulary that includes additional properties desired for the MAP system 10.

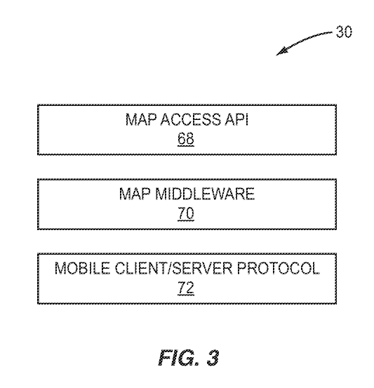

FIG. 3 illustrates the MAP client 30 of FIG. 1 in more detail according to one embodiment of the present disclosure. As illustrated, in this embodiment, the MAP client 30 includes a MAP access API 68, a MAP middleware component 70, and a mobile client/server protocol component 72. The MAP access API 68 is implemented in software and provides an interface by which the MAP client 30 and the third-party applications 34 are enabled to access the MAP client 30. The MAP middleware component 70 is implemented in software and performs the operations needed for the MAP client 30 to operate as an interface between the MAP application 32 and the third-party applications 34 at the mobile device 18 and the MAP server 12. The mobile client/server protocol component 72 enables communication between the MAP client 30 and the MAP server 12 via a defined protocol.

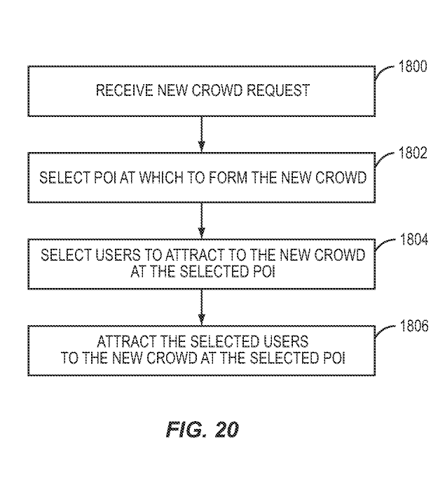

Before proceeding, it should be noted that the primary focus of the present disclosure is the creation of new crowds, which is preferably, but not necessarily, performed by the new crowd engine 62 of the MAP server 12. As discussed below, the new crowd creation process preferably utilizes historical aggregate profile data and/or crowd data for current crowds of users. As such, before describing the new crowd creation process, it is beneficial to describe exemplary processes for storing historical user profile data and exemplary processes for identifying current crowds of users. The description of the new crowd creation process begins at FIG. 20.

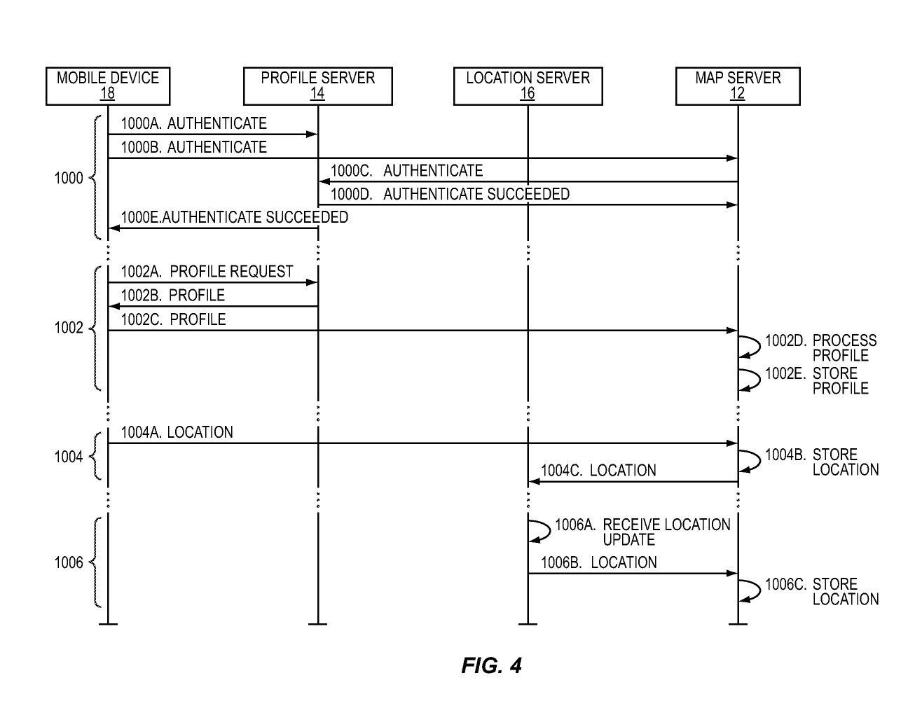

FIG. 4 illustrates the operation of the system 10 of FIG. 1 to provide the user profile of one of the users 20 of one of the mobile devices 18 to the MAP server 12 according to one embodiment of the present disclosure. This discussion is equally applicable to the other users 20 of the other mobile devices 18. First, an authentication process is performed (step 1000). For authentication, in this embodiment, the mobile device 18 authenticates with the profile server 14 (step 1000A) and the MAP server 12 (step 1000B). In addition, the MAP server 12 authenticates with the profile server 14 (step 1000C). Preferably, authentication is preformed using OpenID or similar technology. However, authentication may alternatively be performed using separate credentials (e.g., username and password) of the user 20 for access to the MAP server 12 and the profile server 14. Assuming that authentication is successful, the profile server 14 returns an authentication succeeded message to the MAP server 12 (step 1000D), and the profile server 14 returns an authentication succeeded message to the MAP client 30 of the mobile device 18 (step 1000E).

At some point after authentication is complete, a user profile process is performed such that a user profile of the user 20 is obtained from the profile server 14 and delivered to the MAP server 12 (step 1002). In this embodiment, the MAP client 30 of the mobile device 18 sends a profile request to the profile server 14 (step 1002A). In response, the profile server 14 returns the user profile of the user 20 to the mobile device 18 (step 1002B). The MAP client 30 of the mobile device 18 then sends the user profile of the user 20 to the MAP server 12 (step 1002C). Note that while in this embodiment the MAP client 30 sends the complete user profile of the user 20 to the MAP server 12, in an alternative embodiment, the MAP client 30 may filter the user profile of the user 20 according to criteria specified by the user 20. For example, the user profile of the user 20 may include demographic information, general interests, music interests, and movie interests, and the user 20 may specify that the demographic information or some subset thereof is to be filtered, or removed, before sending the user profile to the MAP server 12.

Upon receiving the user profile of the user 20 from the MAP client 30 of the mobile device 18, the profile manager 52 of the MAP server 12 processes the user profile (step 1002D). More specifically, in the preferred embodiment, the profile manager 52 includes social network handlers for the social network services supported by the MAP server 12. Thus, for example, if the MAP server 12 supports user profiles from Facebook®, MySpace®, and LinkedIN®, the profile manager 52 may include a Facebook handler, a MySpace handler, and a LinkedIN handler. The social network handlers process user profiles to generate user profiles for the MAP server 12 that include lists of keywords for each of a number of profile categories. The profile categories may be the same for each of the social network handlers or different for each of the social network handlers. Thus, for this example assume that the user profile of the user 20 is from Facebook®. The profile manager 52 uses a Facebook handler to process the user profile of the user 20 to map the user profile of the user 20 from Facebook® to a user profile for the MAP server 12 including lists of keywords for a number of predefined profile categories. For example, for the Facebook handler, the profile categories may be a demographic profile category, a social interaction profile category, a general interests profile category, a music interests profile category, and a movie interests profile category. As such, the user profile of the user 20 from Facebook® may be processed by the Facebook handler of the profile manager 52 to create a list of keywords such as, for example, liberal, High School Graduate, 35-44, College Graduate, etc. for the demographic profile category; a list of keywords such as Seeking Friendship for the social interaction profile category; a list of keywords such as politics, technology, photography, books, etc. for the general interests profile category; a list of keywords including music genres, artist names, album names, or the like for the music interests profile category; and a list of keywords including movie titles, actor or actress names, director names, move genres, or the like for the movie interests profile category. In one embodiment, the profile manager 52 may use natural language processing or semantic analysis. For example, if the Facebook user profile of the user 20 states that the user 20 is 20 years old, semantic analysis may result in the keyword of 18-24 years old being stored in the user profile of the user 20 for the MAP server 12.

After processing the user profile of the user 20, the profile manager 52 of the MAP server 12 stores the resulting user profile for the user 20 (step 1002E). More specifically, in one embodiment, the MAP server 12 stores user records for the users 20 through 20-N in the datastore 66 (FIG. 2). The user profile of the user 20 is stored in the user record of the user 20. The user record of the user 20 includes a unique identifier of the user 20, the user profile of the user 20, and, as discussed below, a current location of the user 20. Note that the user profile of the user 20 may be updated as desired. For example, in one embodiment, the user profile of the user 20 is updated by repeating step 1002 each time the user 20 activates the MAP application 32.

Note that the while the discussion herein focuses on an embodiment where the user profiles of the users 20 are obtained from the one or more profile servers 14, the user profiles of the users 20 may be obtained in any desired manner. For example, in one alternative embodiment, the user 20 may identify one or more favorite websites. The profile manager 52 of the MAP server 12 may then crawl the one or more favorite websites of the user 20 to obtain keywords appearing in the one or more favorite websites of the user 20. These keywords may then be stored as the user profile of the user 20.

At some point, a process is performed such that a current location of the mobile device 18 and thus a current location of the user 20 is obtained by the MAP server 12 (step 1004). In this embodiment, the MAP application 32 of the mobile device 18 obtains the current location of the mobile device 18 from the location function 36 of the mobile device 18. The MAP application 32 then provides the current location of the mobile device 18 to the MAP client 30, and the MAP client 30 then provides the current location of the mobile device 18 to the MAP server 12 (step 1004A). Note that step 1004A may be repeated periodically or in response to a change in the current location of the mobile device 18 in order for the MAP application 32 to provide location updates for the user 20 to the MAP server 12.

In response to receiving the current location of the mobile device 18, the location manager 54 of the MAP server 12 stores the current location of the mobile device 18 as the current location of the user 20 (step 1004B). More specifically, in one embodiment, the current location of the user 20 is stored in the user record of the user 20 maintained in the datastore 66 of the MAP server 12. Note that, in the preferred embodiment, only the current location of the user 20 is stored in the user record of the user 20. In this manner, the MAP server 12 maintains privacy for the user 20 since the MAP server 12 does not maintain a historical record of the location of the user 20. As discussed below in detail, historical data maintained by the MAP server 12 is preferably anonymized in order to maintain the privacy of the users 20.

In addition to storing the current location of the user 20, the location manager 54 sends the current location of the user 20 to the location server 16 (step 1004C). In this embodiment, by providing location updates to the location server 16, the MAP server 12 in return receives location updates for the user 20 from the location server 16. This is particularly beneficial when the mobile device 18 does not permit background processes. If the mobile device 18 does not permit background processes, the MAP application 32 will not be able to provide location updates for the user 20 to the MAP server 12 unless the MAP application 32 is active. Therefore, when the MAP application 32 is not active, other applications running on the mobile device 18 (or some other device of the user 20) may directly or indirectly provide location updates to the location server 16 for the user 20. This is illustrated in step 1006 where the location server 16 receives a location update for the user 20 directly or indirectly from another application running on the mobile device 18 or an application running on another device of the user 20 (step 1006A). The location server 16 then provides the location update for the user 20 to the MAP server 12 (step 1006B). In response, the location manager 54 updates and stores the current location of the user 20 in the user record of the user 20 (step 1006C). In this manner, the MAP server 12 is enabled to obtain location updates for the user 20 even when the MAP application 32 is not active at the mobile device 18.

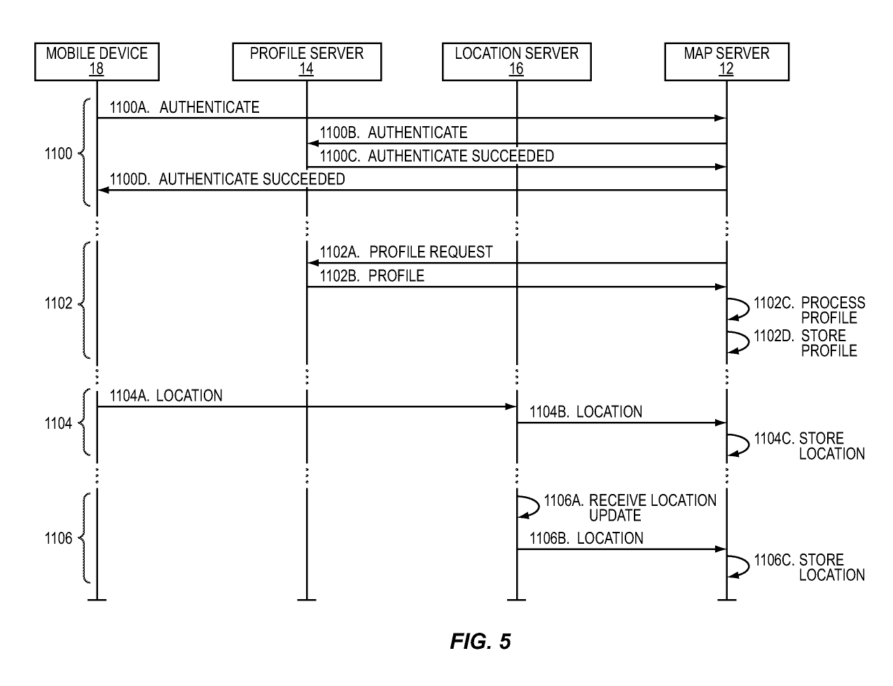

FIG. 5 illustrates the operation of the system 10 of FIG. 1 to provide the user profile of the user 20 of one of the mobile device 18 to the MAP server 12 according to another embodiment of the present disclosure. This discussion is equally applicable to user profiles of the users 20 of the other mobile devices 18. First, an authentication process is performed (step 1100). For authentication, in this embodiment, the mobile device 18 authenticates with the MAP server 12 (step 1100A), and the MAP server 12 authenticates with the profile server 14 (step 1100B). Preferably, authentication is performed using Open ID or similar technology. However, authentication may alternatively be performed using separate credentials (e.g., username and password) of the user 20 for access to the MAP server 12 and the profile server 14. Assuming that authentication is successful, the profile server 14 returns an authentication succeeded message to the MAP server 12 (step 1100C), and the MAP server 12 returns an authentication succeeded message to the MAP client 30 of the mobile device 18 (step 1100D).

At some point after authentication is complete, a user profile process is performed such that a user profile of the user 20 is obtained from the profile server 14 and delivered to the MAP server 12 (step 1102). In this embodiment, the profile manager 52 of the MAP server 12 sends a profile request to the profile server 14 (step 1102A). In response, the profile server 14 returns the user profile of the user 20 to the profile manager 52 of the MAP server 12 (step 1102B). Note that while in this embodiment the profile server 14 returns the complete user profile of the user 20 to the MAP server 12, in an alternative embodiment, the profile server 14 may return a filtered version of the user profile of the user 20 to the MAP server 12. The profile server 14 may filter the user profile of the user 20 according to criteria specified by the user 20. For example, the user profile of the user 20 may include demographic information, general interests, music interests, and movie interests, and the user 20 may specify that the demographic information or some subset thereof is to be filtered, or removed, before sending the user profile to the MAP server 12.

Upon receiving the user profile of the user 20, the profile manager 52 of the MAP server 12 processes to the user profile (step 1102C). More specifically, as discussed above, in the preferred embodiment, the profile manager 52 includes social network handlers for the social network services supported by the MAP server 12. The social network handlers process user profiles to generate user profiles for the MAP server 12 that include lists of keywords for each of a number of profile categories. The profile categories may be the same for each of the social network handlers or different for each of the social network handlers.

After processing the user profile of the user 20, the profile manager 52 of the MAP server 12 stores the resulting user profile for the user 20 (step 1102D). More specifically, in one embodiment, the MAP server 12 stores user records for the users 20 in the datastore 66 (FIG. 2). The user profile of the user 20 is stored in the user record of the user 20. The user record of the user 20 includes a unique identifier of the user 20, the user profile of the user 20, and, as discussed below, a current location of the user 20. Note that the user profile of the user 20 may be updated as desired. For example, in one embodiment, the user profile of the user 20 is updated by repeating step 1102 each time the user 20 activates the MAP application 32.

Note that the while the discussion herein focuses on an embodiment where the user profiles of the users 20 are obtained from the one or more profile servers 14, the user profiles of the users 20 may be obtained in any desired manner. For example, in one alternative embodiment, the user 20 may identify one or more favorite websites. The profile manager 52 of the MAP server 12 may then crawl the one or more favorite websites of the user 20 to obtain keywords appearing in the one or more favorite websites of the user 20. These keywords may then be stored as the user profile of the user 20.

At some point, a process is performed such that a current location of the mobile device 18 and thus a current location of the user 20 is obtained by the MAP server 12 (step 1104). In this embodiment, the MAP application 32 of the mobile device 18 obtains the current location of the mobile device 18 from the location function 36 of the mobile device 18. The MAP application 32 then provides the current location of the user 20 of the mobile device 18 to the location server 16 (step 1104A). Note that step 1104A may be repeated periodically or in response to changes in the location of the mobile device 18 in order to provide location updates for the user 20 to the MAP server 12. The location server 16 then provides the current location of the user 20 to the MAP server 12 (step 1104B). The location server 16 may provide the current location of the user 20 to the MAP server 12 automatically in response to receiving the current location of the user 20 from the mobile device 18 or in response to a request from the MAP server 12.

In response to receiving the current location of the mobile device 18, the location manager 54 of the MAP server 12 stores the current location of the mobile device 18 as the current location of the user 20 (step 1104C). More specifically, in one embodiment, the current location of the user 20 is stored in the user record of the user 20 maintained in the datastore 66 of the MAP server 12. Note that, in the preferred embodiment, only the current location of the user 20 is stored in the user record of the user 20. In this manner, the MAP server 12 maintains privacy for the user 20 since the MAP server 12 does not maintain a historical record of the location of the user 20. As discussed below in detail, historical data maintained by the MAP server 12 is preferably anonymized in order to maintain the privacy of the users 20.

As discussed above, the use of the location server 16 is particularly beneficial when the mobile device 18 does not permit background processes. As such, if the mobile device 18 does not permit background processes, the MAP application 32 will not provide location updates for the user 20 to the location server 16 unless the MAP application 32 is active. However, other applications running on the mobile device 18 (or some other device of the user 20) may provide location updates to the location server 16 for the user 20 when the MAP application 32 is not active. This is illustrated in step 1106 where the location server 16 receives a location update for the user 20 from another application running on the mobile device 18 or an application running on another device of the user 20 (step 1106A). The location server 16 then provides the location update for the user 20 to the MAP server 12 (step 1106B). In response, the location manager 54 updates and stores the current location of the user 20 in the user record of the user 20 (step 1106C). In this manner, the MAP server 12 is enabled to obtain location updates for the user 20 even when the MAP application 32 is not active at the mobile device 18.

Using the current locations of the users 20 and the user profiles of the users 20, the MAP server 12 can provide a number of features. A first feature that may be provided by the MAP server 12 is historical storage of anonymized user profile data by location. This historical storage of anonymized user profile data by location is performed by the history manager 56 of the MAP server 12. More specifically, as illustrated in FIG. 6, in the preferred embodiment, the history manager 56 maintains lists of users located in a number of geographic regions, or “location buckets.” Preferably, the location buckets are defined by floor (latitude, longitude) to a desired resolution. The higher the resolution, the smaller the size of the location buckets. For example, in one embodiment, the location buckets are defined by floor (latitude, longitude) to a resolution of 1/10,000^{th} of a degree such that the lower left-hand corners of the squares illustrated in FIG. 6 are defined by the floor(latitude, longitude) values at a resolution of 1/10,000^{th} of a degree. In the example of FIG. 6, users are represented as dots, and location buckets 74 through 90 have lists of 1, 3, 2, 1, 1, 2, 1, 2, and 3 users, respectively.

As discussed below in detail, at a predetermined time interval such as, for example, 15 minutes, the history manager 56 makes a copy of the lists of users in the location buckets, anonymizes the user profiles of the users in the lists to provide anonymized user profile data for the corresponding location buckets, and stores the anonymized user profile data in a number of history objects. In one embodiment, a history object is stored for each location bucket having at least one user. In another embodiment, a quadtree algorithm is used to efficiently create history objects for geographic regions (i.e., groups of one or more adjoining location buckets).

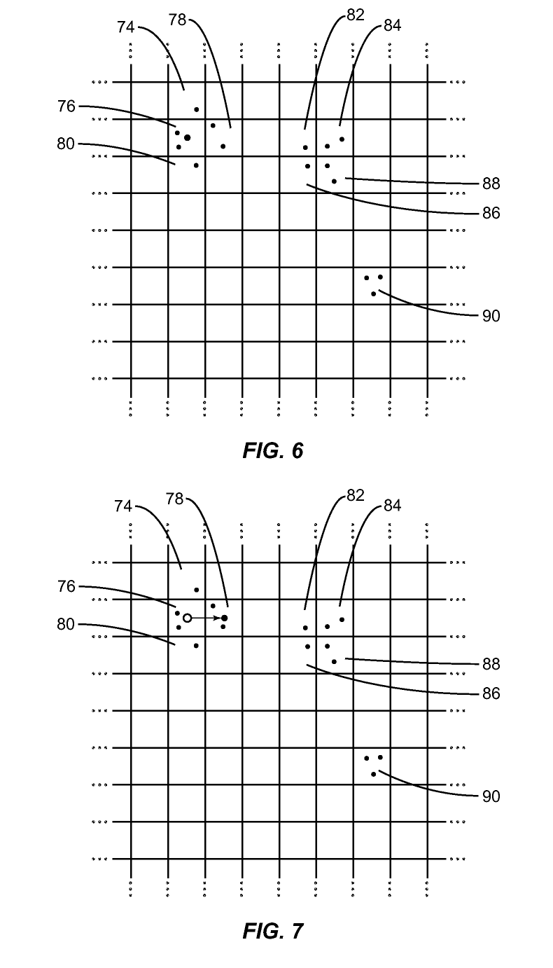

FIG. 7 graphically illustrates a scenario where a user moves from one location bucket to another, namely, from the location bucket 76 to the location bucket 78. As discussed below in detail, assuming that the movement occurs during the time interval between persistence of the historical data by the history manager 56, the user is included on both the list for the location bucket 76 and the list for the location bucket 78. However, the user is flagged or otherwise marked as inactive for the location bucket 76 and active for the location bucket 78. As discussed below, after making a copy of the lists for the location buckets to be used to persist the historical data, users flagged as inactive are removed from the lists of users for the location buckets. Thus, in sum, once a user moves from the location bucket 76 to the location bucket 78, the user remains in the list for the location bucket 76 until the predetermined time interval has expired and the anonymized user profile data is persisted. The user is then removed from the list for the location bucket 76.

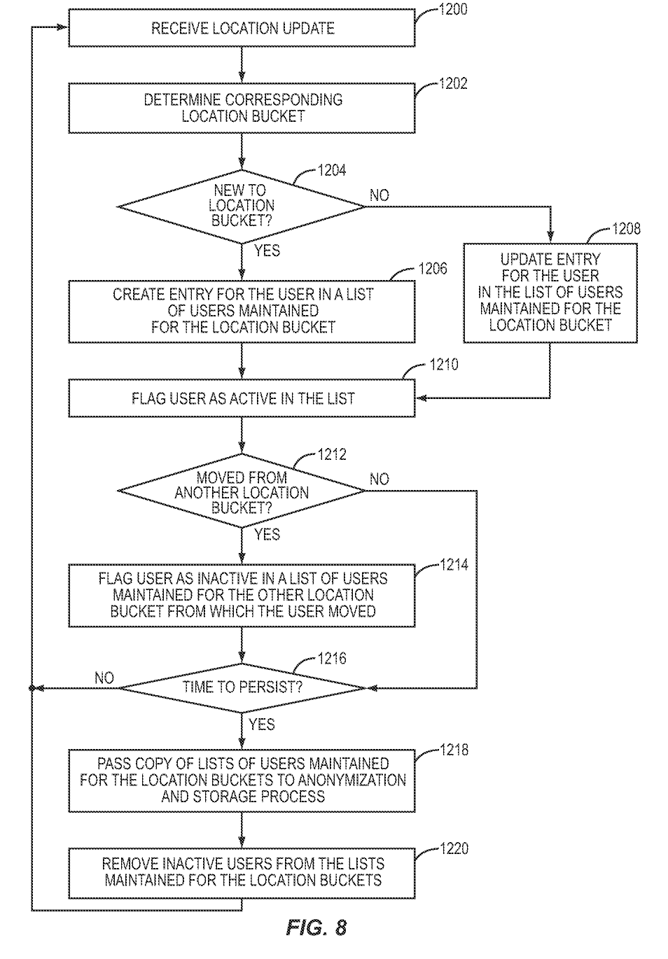

FIG. 8 is a flow chart illustrating the operation of a foreground “bucketization” process performed by the history manager 56 to maintain the lists of users for location buckets according to one embodiment of the present disclosure. First, the history manager 56 receives a location update for one of the users 20 (step 1200). The history manager 56 then determines a location bucket corresponding to the updated location (i.e., the current location) of the user 20 (step 1202). In the preferred embodiment, the location of the user 20 is expressed as latitude and longitude coordinates, and the history manager 56 determines the location bucket by determining floor values of the latitude and longitude coordinates, which can be written as floor(latitude, longitude) at a desired resolution. As an example, if the latitude and longitude coordinates for the location of the user 20 are 32.24267381553987 and -111.9249213502935, respectively, and the floor values are to be computed to a resolution of 1/10,000^{th} of a degree, then the floor values for the latitude and longitude coordinates are 32.2426 and −111.9249. The floor values for the latitude and longitude coordinates correspond to a particular location bucket.

After determining the location bucket for the location of the user 20, the history manager 56 determines whether the user 20 is new to the location bucket (step 1204). In other words, the history manager 56 determines whether the user 20 is already on the list of users for the location bucket. If the user 20 is new to the location bucket, the history manager 56 creates an entry for the user 20 in the list of users for the location bucket (step 1206). Returning to step 1204, if the user 20 is not new to the location bucket, the history manager 56 updates the entry for the user 20 in the list of users for the location bucket (step 1208). At this point, whether proceeding from step 1206 or 1208, the user 20 is flagged as active in the list of users for the location bucket (step 1210).

The history manager 56 then determines whether the user 20 has moved from another location bucket (step 1212). More specifically, the history manager 56 determines whether the user 20 is included in the list of users for another location bucket and is currently flagged as active in that list. If the user 20 has not moved from another location bucket, the process proceeds to step 1216. If the user 20 has moved from another location bucket, the history manager 56 flags the user 20 as inactive in the list of users for the other location bucket from which the user 20 has moved (step 1214).

At this point, whether proceeding from step 1212 or 1214, the history manager 56 determines whether it is time to persist (step 1216). More specifically, as mentioned above, the history manager 56 operates to persist history objects at a predetermined time interval such as, for example, every 15 minutes. Thus, the history manager 56 determines that it is time to persist if the predetermined time interval has expired. If it is not time to persist, the process returns to step 1200 and is repeated for a next received location update, which will typically be for another user. If it is time to persist, the history manager 56 creates a copy of the lists of users for the location buckets and passes the copy of the lists to an anonymization and storage process (step 1218). In this embodiment, the anonymization and storage process is a separate process performed by the history manager 56. The history manager 56 then removes inactive users from the lists of users for the location buckets (step 1220). The process then returns to step 1200 and is repeated for a next received location update, which will typically be for another user.

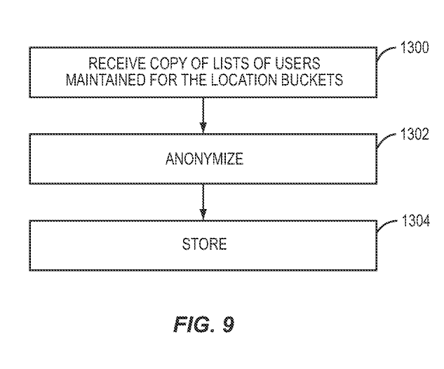

FIG. 9 is a flow chart illustrating the anonymization and storage process performed by the history manager 56 at the predetermined time interval according to one embodiment of the present disclosure. First, the anonymization and storage process receives the copy of the lists of users for the location buckets passed to the anonymization and storage process by the bucketization process of FIG. 8 (step 1300). Next, anonymization is performed for each of the location buckets having at least one user in order to provide anonymized user profile data for the location buckets (step 1302). Anonymization prevents connecting information stored in the history objects stored by the history manager 56 back to the users 20 or at least substantially increases a difficulty of connecting information stored in the history objects stored by the history manager 56 back to the users 20. Lastly, the anonymized user profile data for the location buckets is stored in a number of history objects (step 1304). In one embodiment, a separate history object is stored for each of the location buckets, where the history object of a location bucket includes the anonymized user profile data for the location bucket. In another embodiment, as discussed below, a quadtree algorithm is used to efficiently store the anonymized user profile data in a number of history objects such that each history object stores the anonymized user profile data for one or more location buckets.

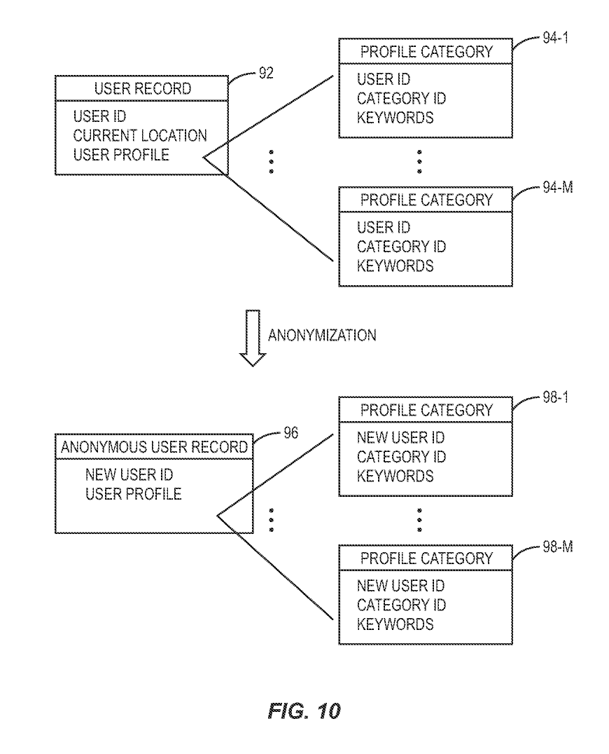

FIG. 10 graphically illustrates one embodiment of the anonymization process of step 1302 of FIG. 9. In this embodiment, anonymization is performed by creating anonymous user records for the users in the lists of users for the location buckets. The anonymous user records are not connected back to the users 20. More specifically, as illustrated in FIG. 10, each user in the lists of users for the location buckets has a corresponding user record 92. The user record 92 includes a unique user identifier (ID) for the user, the current location of the user, and the user profile of the user. The user profile includes keywords for each of a number of profile categories, which are stored in corresponding profile category records 94-1 through 94-M. Each of the profile category records 94-1 through 94-M includes a user ID for the corresponding user which may be the same user ID used in the user record 92, a category ID, and a list of keywords for the profile category.

For anonymization, an anonymous user record 96 is created from the user record 92. In the anonymous user record 96, the user ID is replaced with a new user ID that is not connected back to the user, which is also referred to herein as an anonymous user ID. This new user ID is different than any other user ID used for anonymous user records created from the user record of the user for any previous or subsequent time periods. In this manner, anonymous user records for a single user created over time cannot be linked to one another.

In addition, anonymous profile category records 98-1 through 98-M are created for the profile category records 94-1 through 94-M. In the anonymous profile category records 98-1 through 98-M, the user ID is replaced with a new user ID, which may be the same new user ID included in the anonymous user record 96. The anonymous profile category records 98-1 through 98-M include the same category IDs and lists of keywords as the corresponding profile category records 94-1 through 94-M. Note that the location of the user is not stored in the anonymous user record 96. With respect to location, it is sufficient that the anonymous user record 96 is linked to a location bucket.

In another embodiment, the history manager 56 performs anonymization in a manner similar to that described above with respect to FIG. 10. However, in this embodiment, the profile category records for the group of users in a location bucket, or the group of users in a number of location buckets representing a node in a quadtree data structure (see below), may be selectively randomized among the anonymous user records of those users. In other words, each anonymous user record would have a user profile including a selectively randomized set of profile category records (including keywords) from a cumulative list of profile category records for all of the users in the group.

In yet another embodiment, rather than creating anonymous user records 96 for the users in the lists maintained for the location buckets, the history manager 56 may perform anonymization by storing an aggregate user profile for each location bucket, or each group of location buckets representing a node in a quadtree data structure (see below). The aggregate user profile may include a list of all keywords and potentially the number of occurrences of each keyword in the user profiles of the corresponding group of users. In this manner, the data stored by the history manager 56 is not connected back to the users 20.

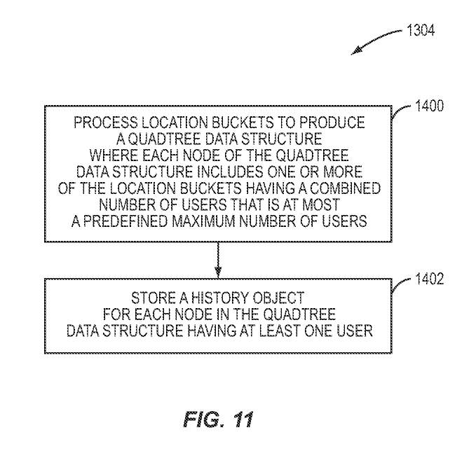

FIG. 11 is a flow chart illustrating the storing step (step 1304) of FIG. 9 in more detail according to one embodiment of the present disclosure. First, the history manager 56 processes the location buckets using a quadtree algorithm to produce a quadtree data structure, where each node of the quadtree data structure includes one or more of the location buckets having a combined number of users that is at most a predefined maximum number of users (step 1400). The history manager 56 then stores a history object for each node in the quadtree data structure having at least one user (step 1402).

Each history object includes location information, timing information, data, and quadtree data structure information. The location information included in the history object defines a combined geographic area of the location bucket(s) forming the corresponding node of the quadtree data structure. For example, the location information may be latitude and longitude coordinates for a northeast corner of the combined geographic area of the node of the quadtree data structure and a southwest corner of the combined geographic area for the node of the quadtree data structure. The timing information includes information defining a time window for the history object, which may be, for example, a start time for the corresponding time interval and an end time for the corresponding time interval. The data includes the anonymized user profile data for the users in the list(s) maintained for the location bucket(s) forming the node of the quadtree data structure for which the history object is stored. In addition, the data may include a total number of users in the location bucket(s) forming the node of the quadtree data structure. Lastly, the quadtree data structure information includes information defining a quadtree depth of the node in the quadtree data structure.

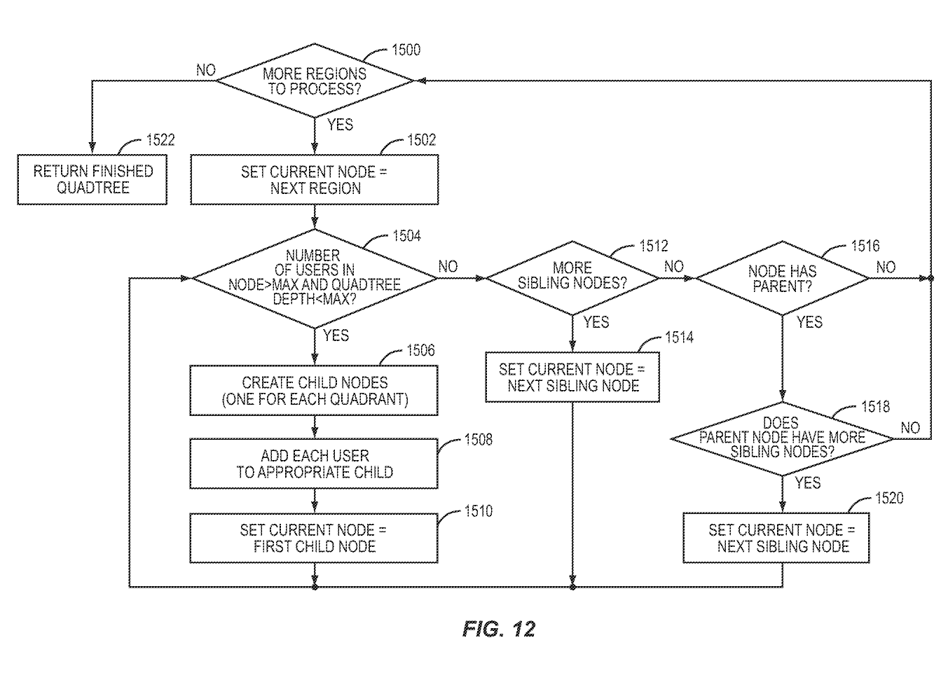

FIG. 12 is a flow chart illustrating a quadtree algorithm that may be used to process the location buckets to form the quadtree data structure in step 1400 of FIG. 11 according to one embodiment of the present disclosure. Initially, a geographic area served by the MAP server 12 is divided into a number of geographic regions, each including multiple location buckets. These geographic regions are also referred to herein as base quadtree regions. The geographic area served by the MAP server 12 may be, for example, a city, a state, a country, or the like. Further, the geographic area may be the only geographic area served by the MAP server 12 or one of a number of geographic areas served by the MAP server 12. Preferably, the base quadtree regions have a size of 2ⁿ×2ⁿ location buckets, where n is an integer greater than or equal to 1.

In order to form the quadtree data structure, the history manager 56 determines whether there are any more base quadtree regions to process (step 1500). If there are more base quadtree regions to process, the history manager 56 sets a current node to the next base quadtree region to process, which for the first iteration is the first base quadtree region (step 1502). The history manager 56 then determines whether the number of users in the current node is greater than a predefined maximum number of users and whether a current quadtree depth is less than a maximum quadtree depth (step 1504). In one embodiment, the maximum quadtree depth may be reached when the current node corresponds to a single location bucket. However, the maximum quadtree depth may be set such that the maximum quadtree depth is reached before the current node reaches a single location bucket.

If the number of users in the current node is greater than the predefined maximum number of users and the current quadtree depth is less than a maximum quadtree depth, the history manager 56 creates a number of child nodes for the current node (step 1506). More specifically, the history manager 56 creates a child node for each quadrant of the current node. The users in the current node are then assigned to the appropriate child nodes based on the location buckets in which the users are located (step 1508), and the current node is then set to the first child node (step 1510). At this point, the process returns to step 1504 and is repeated.

Once the number of users in the current node is not greater than the predefined maximum number of users or the maximum quadtree depth has been reached, the history manager 56 determines whether the current node has any more sibling nodes (step 1512). Sibling nodes are child nodes of the same parent node. If so, the history manager 56 sets the current node to the next sibling node of the current node (step 1514), and the process returns to step 1504 and is repeated. Once there are no more sibling nodes to process, the history manager 56 determines whether the current node has a parent node (step 1516). If so, since the parent node has already been processed, the history manager 56 determines whether the parent node has any sibling nodes that need to be processed (step 1518). If the parent node has any sibling nodes that need to be processed, the history manager 56 sets the next sibling node of the parent node to be processed as the current node (step 1520). From this point, the process returns to step 1504 and is repeated. Returning to step 1516, if the current node does not have a parent node, the process returns to step 1500 and is repeated until there are no more base quadtree regions to process. Once there are no more base quadtree regions to process, the finished quadtree data structure is returned to the process of FIG. 11 such that the history manager 56 can then store the history objects for nodes in the quadtree data structure having at least one user (step 1522).

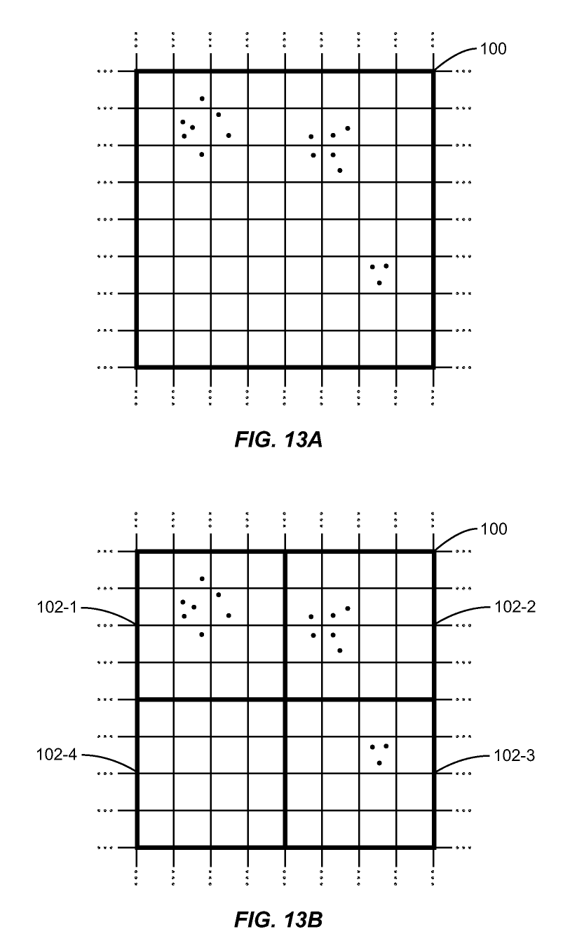

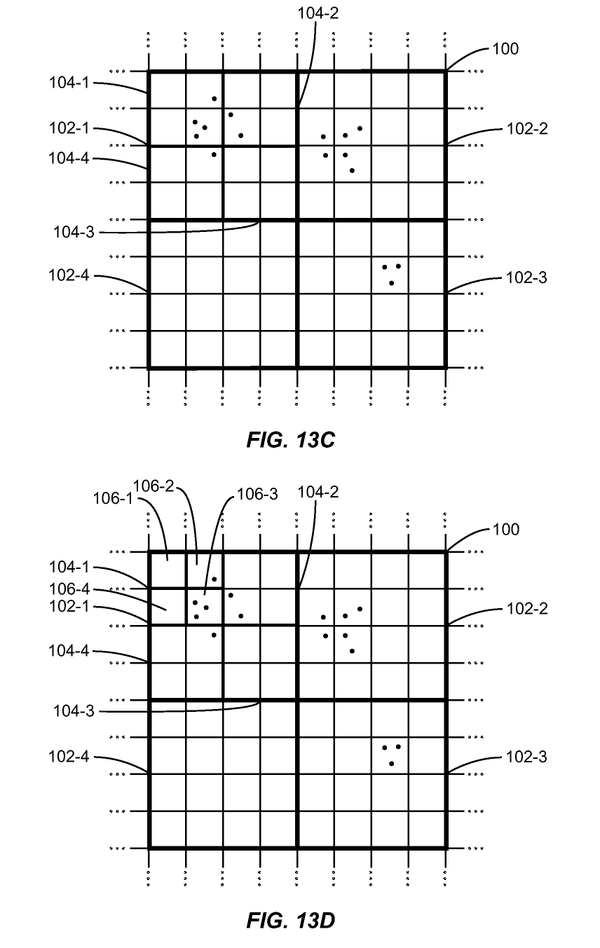

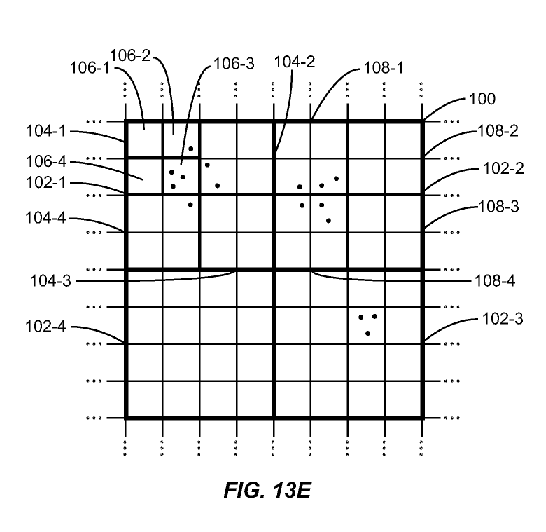

FIGS. 13A through 13E graphically illustrate the process of FIG. 12 for the generation of the quadtree data structure for one exemplary base quadtree region 100. FIG. 13A illustrates the base quadtree region 100. As illustrated, the base quadtree region 100 is an 8×8 square of location buckets, where each of the small squares represents a location bucket. First, the history manager 56 determines whether the number of users in the base quadtree region 100 is greater than the predetermined maximum number of users. In this example, the predetermined maximum number of users is 3. Since the number of users in the base quadtree region 100 is greater than 3, the history manager 56 divides the base quadtree region 100 into four child nodes 102-1 through 102-4, as illustrated in FIG. 13B.

Next, the history manager 56 determines whether the number of users in the child node 102-1 is greater than the predetermined maximum, which again for this example is 3. Since the number of users in the child node 102-1 is greater than 3, the history manager 56 divides the child node 102-1 into four child nodes 104-1 through 104-4, as illustrated in FIG. 13C. The child nodes 104-1 through 104-4 are children of the child node 102-1. The history manager 56 then determines whether the number of users in the child node 104-1 is greater than the predetermined maximum number of users, which again is 3. Since there are more than 3 users in the child node 104-1, the history manager 56 further divides the child node 104-1 into four child nodes 106-1 through 106-N, as illustrated in FIG. 13D.

The history manager 56 then determines whether the number of users in the child node 106-1 is greater than the predetermined maximum number of users, which again is 3. Since the number of users in the child node 106-1 is not greater than the predetermined maximum number of users, the child node 106-1 is identified as a node for the finished quadtree data structure, and the history manager 56 proceeds to process the sibling nodes of the child node 106-1, which are the child nodes 106-2 through 106-4. Since the number of users in each of the child nodes 106-2 through 106-4 is less than the predetermined maximum number of users, the child nodes 106-2 through 106-4 are also identified as nodes for the finished quadtree data structure.

Once the history manager 56 has finished processing the child nodes 106-1 through 106-4, the history manager 56 identifies the parent node of the child nodes 106-1 through 106-4, which in this case is the child node 104-1. The history manager 56 then processes the sibling nodes of the child node 104-1, which are the child nodes 104-2 through 104-4. In this example, the number of users in each of the child nodes 104-2 through 104-4 is less than the predetermined maximum number of users. As such, the child nodes 104-2 through 104-4 are identified as nodes for the finished quadtree data structure.

Once the history manager 56 has finished processing the child nodes 104-1 through 104-4, the history manager 56 identifies the parent node of the child nodes 104-1 through 104-4, which in this case is the child node 102-1. The history manager 56 then processes the sibling nodes of the child node 102-1, which are the child nodes 102-2 through 102-4. More specifically, the history manager 56 determines that the child node 102-2 includes more than the predetermined maximum number of users and, as such, divides the child node 102-2 into four child nodes 108-1 through 108-4, as illustrated in FIG. 13E. Because the number of users in each of the child nodes 108-1 through 108-4 is not greater than the predetermined maximum number of users, the child nodes 108-1 through 108-4 are identified as nodes for the finished quadtree data structure. Then, the history manager 56 proceeds to process the child nodes 102-3 and 102-4. Since the number of users in each of the child nodes 102-3 and 102-4 is not greater than the predetermined maximum number of users, the child nodes 102-3 and 102-4 are identified as nodes for the finished quadtree data structure. Thus, at completion, the quadtree data structure for the base quadtree region 100 includes the child nodes 106-1 through 106-4, the child nodes 104-2 through 104-4, the child nodes 108-1 through 108-4, and the child nodes 102-3 and 102-4, as illustrated in FIG. 13E.

As discussed above, the history manager 56 stores a history object for each of the nodes in the quadtree data structure including at least one user. As such, in this example, the history manager 56 stores history objects for the child nodes 106-2 and 106-3, the child nodes 104-2 and 104-4, the child nodes 108-1 and 108-4, and the child node 102-3. However, no history objects are stored for the nodes that do not have any users (i.e., the child nodes 106-1 and 106-4, the child node 104-3, the child nodes 108-2 and 108-3, and the child node 102-4).

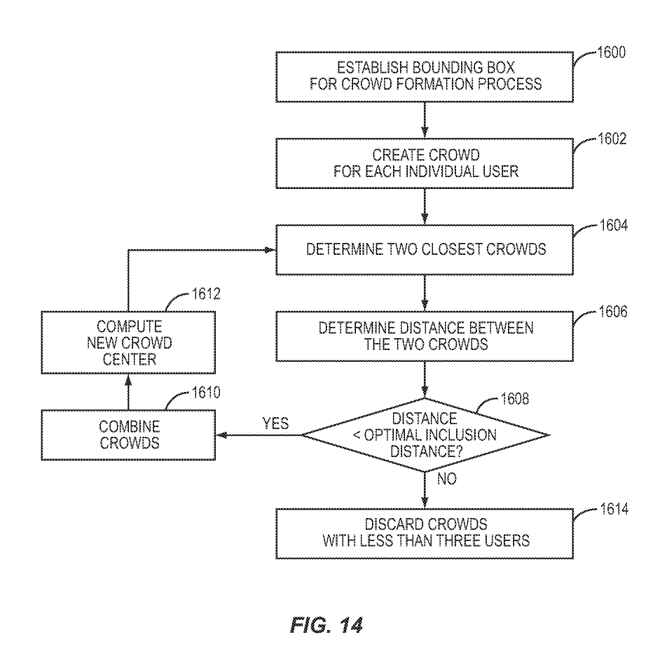

FIG. 14 begins a discussion of the operation of the crowd analyzer 58 to form crowds of users according to one embodiment of the present disclosure. Specifically, FIG. 14 is a flow chart for a spatial crowd formation process according to one embodiment of the present disclosure. Note that, in one embodiment, this process is performed in response to a request for crowd data for a POI or an AOI. In another embodiment, this process may be performed proactively by the crowd analyzer 58 as, for example, a background process.

First, the crowd analyzer 58 establishes a bounding box for the crowd formation process (step 1600). Note that while a bounding box is used in this example, other geographic shapes may be used to define a bounding region for the crowd formation process (e.g., a bounding circle). In one embodiment, if crowd formation is performed in response to a specific request, the bounding box is established based on the POI or the AOI of the request. If the request is for a POI, then the bounding box is a geographic area of a predetermined size centered at the POI. If the request is for an AOI, the bounding box is the AOI. Alternatively, if the crowd formation process is performed proactively, the bounding box is a bounding box of a predefined size.

The crowd analyzer 58 then creates a crowd for each individual user in the bounding box (step 1602). More specifically, the crowd analyzer 58 queries the datastore 66 of the MAP server 12 to identify users currently located within the bounding box. Then, a crowd of one user is created for each user currently located within the bounding box. Next, the crowd analyzer 58 determines the two closest crowds in the bounding box (step 1604) and determines a distance between the two crowds (step 1606). The distance between the two crowds is a distance between crowd centers of the two crowds. Note that the crowd center of a crowd of one is the current location of the user in the crowd. The crowd analyzer 58 then determines whether the distance between the two crowds is less than an optimal inclusion distance (step 1608). In this embodiment, the optimal inclusion distance is a predefined static distance. If the distance between the two crowds is less than the optimal inclusion distance, the crowd analyzer 58 combines the two crowds (step 1610) and computes a new crowd center for the resulting crowd (step 1612). The crowd center may be computed based on the current locations of the users in the crowd using a center of mass algorithm. At this point the process returns to step 1604 and is repeated until the distance between the two closest crowds is not less than the optimal inclusion distance. At that point, the crowd analyzer 58 discards any crowds with less than three users (step 1614). Note that throughout this disclosure crowds are only maintained if the crowds include three or more users. However, while three users is the preferred minimum number of users in a crowd, the present disclosure is not limited thereto. The minimum number of users in a crowd may be defined as any number greater than or equal to two users.

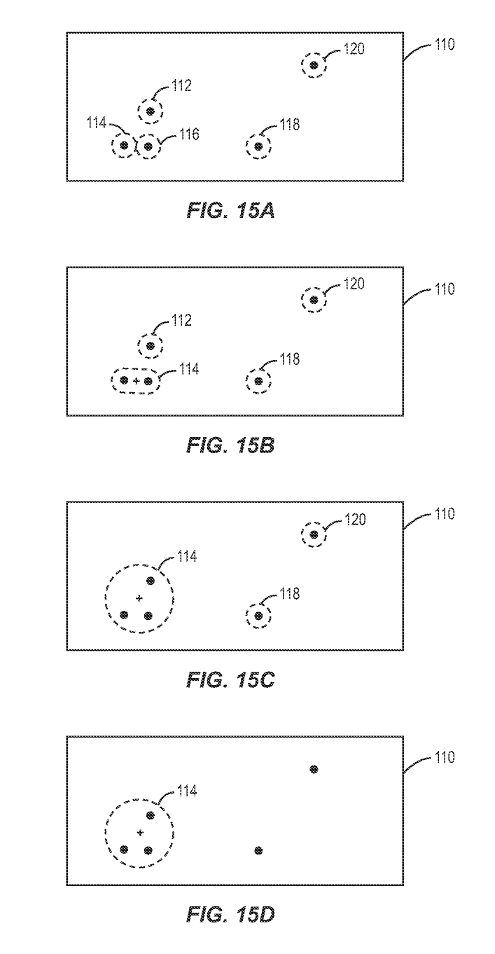

FIGS. 15A through 15D graphically illustrate the crowd formation process of FIG. 14 for an exemplary bounding box 110. In FIGS. 15A through 15D, crowds are noted by dashed circles, and the crowd centers are noted by cross-hairs (+). As illustrated in FIG. 15A, initially, the crowd analyzer 58 creates crowds 112 through 120 for the users in the geographic area, where, at this point, each of the crowds 112 through 120 includes one user. The current locations of the users are the crowd centers of the crowds 112 through 120. Next, the crowd analyzer 58 determines the two closest crowds and a distance between the two closest crowds. In this example, at this point, the two closest crowds are crowds 114 and 116, and the distance between the two closest crowds 114 and 116 is less than the optimal inclusion distance. As such, the two closest crowds 114 and 116 are combined by merging crowd 116 into crowd 114, and a new crowd center (+) is computed for the crowd 114, as illustrated in FIG. 15B. Next, the crowd analyzer 58 again determines the two closest crowds, which are now crowds 112 and 114. The crowd analyzer 58 then determines a distance between the crowds 112 and 114. Since the distance is less than the optimal inclusion distance, the crowd analyzer 58 combines the two crowds 112 and 114 by merging the crowd 112 into the crowd 114, and a new crowd center (+) is computed for the crowd 114, as illustrated in FIG. 15C. At this point, there are no more crowds separated by less than the optimal inclusion distance. As such, the crowd analyzer 58 discards crowds having less than three users, which in this example are crowds 118 and 120. As a result, at the end of the crowd formation process, the crowd 114 has been formed with three users, as illustrated in FIG. 15D.

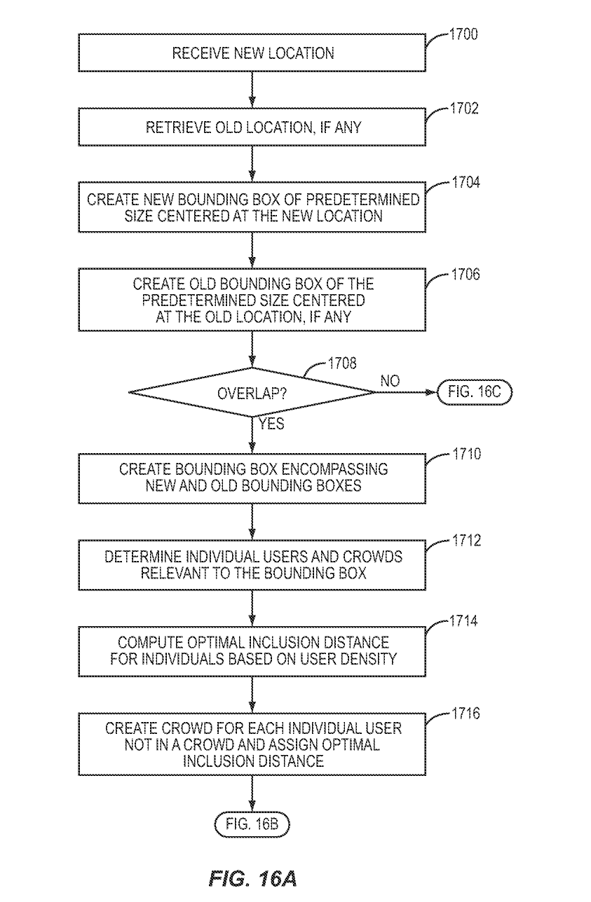

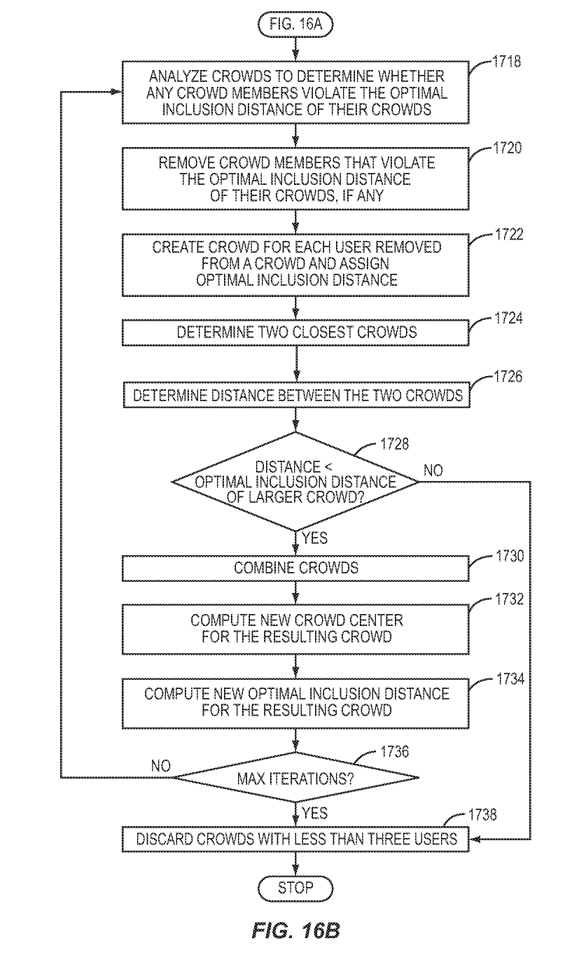

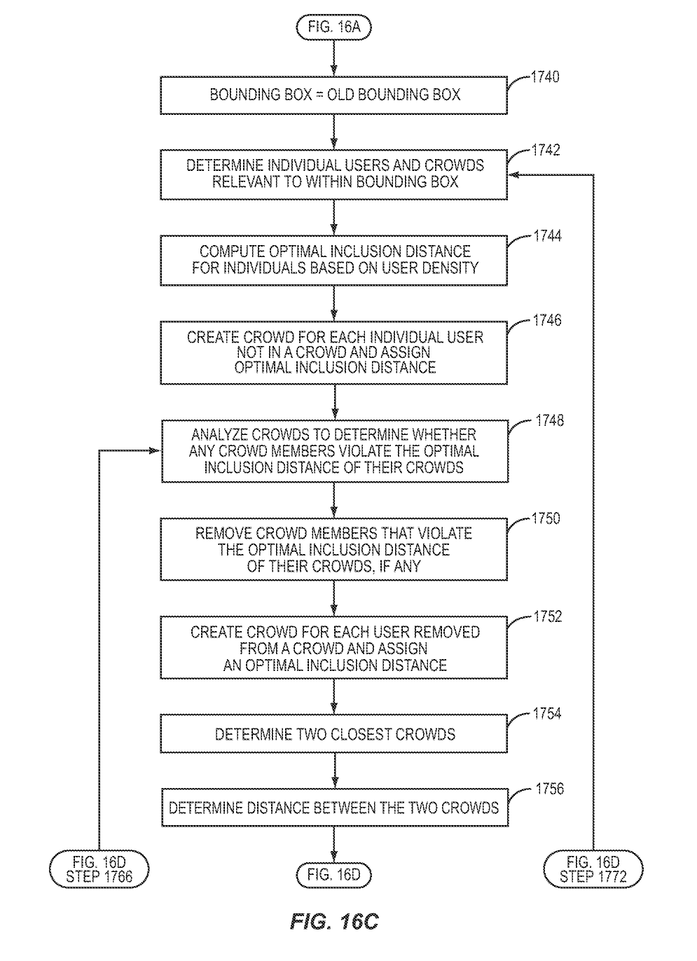

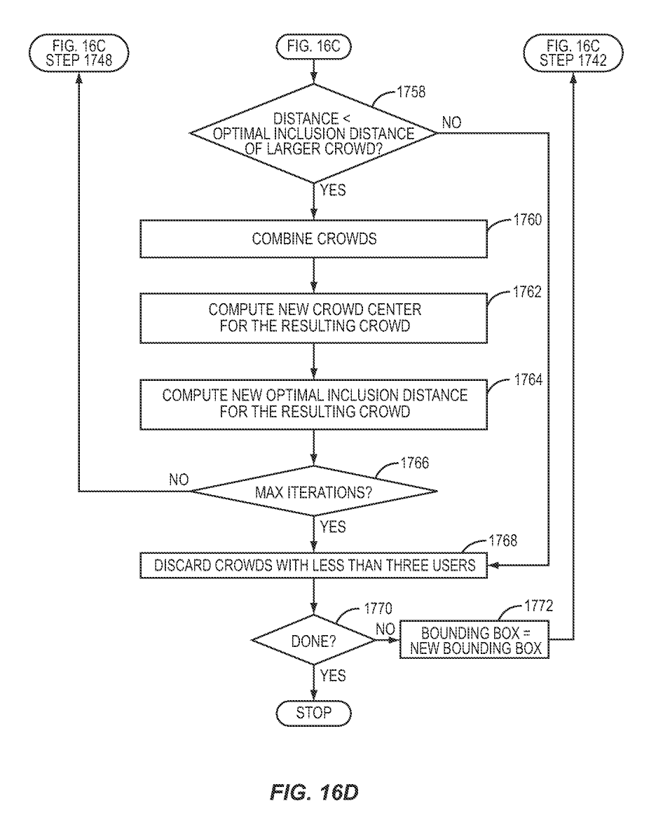

FIGS. 16A through 16D illustrate a flow chart for a spatial crowd formation process according to another embodiment of the present disclosure. In this embodiment, the spatial crowd formation process is triggered in response to receiving a location update for one of the users 20 and is preferably repeated for each location update received for the users 20. As such, first, the crowd analyzer 58 receives a location update, or a new location, for one of the users 20 (step 1700). In response, the crowd analyzer 58 retrieves an old location of the user 20, if any (step 1702). The old location is the current location of the user 20 prior to receiving the new location. The crowd analyzer 58 then creates a new bounding box of a predetermined size centered at the new location of the user 20 (step 1704) and an old bounding box of a predetermined size centered at the old location of the user 20, if any (step 1706). The predetermined size of the new and old bounding boxes may be any desired size. As one example, the predetermined size of the new and old bounding boxes is 40 meters by 40 meters. Note that if the user 20 does not have an old location (i.e., the location received in step 1700 is the first location received for the user 20), then the old bounding box is essentially null. Also note that while bounding “boxes” are used in this example, the bounding areas may be of any desired shape.

Next, the crowd analyzer 58 determines whether the new and old bounding boxes overlap (step 1708). If so, the crowd analyzer 58 creates a bounding box encompassing the new and old bounding boxes (step 1710). For example, if the new and old bounding boxes are 40×40 meter regions and a 1×1 meter square at the northeast corner of the new bounding box overlaps a 1×1 meter square at the southwest corner of the old bounding box, the crowd analyzer 58 may create a 79×79 meter square bounding box encompassing both the new and old bounding boxes.

The crowd analyzer 58 then determines the individual users and crowds relevant to the bounding box created in step 1710 (step 1712). The crowds relevant to the bounding box are crowds that are within or overlap the bounding box (e.g., have at least one user located within the bounding box). The individual users relevant to the bounding box are users that are currently located within the bounding box and not already part of a crowd. Next, the crowd analyzer 58 computes an optimal inclusion distance for individual users based on user density within the bounding box (step 1714). More specifically, in one embodiment, the optimal inclusion distance for individuals, which is also referred to herein as an initial optimal inclusion distance, is set according to the following equation:

$$initial\_optimal \_inclusion \_dist = a \cdot \sqrt{\frac{{A}_{BoundingBox}}{number\_of \_users}} ,$$

where a is a number between 0 and 1, A_{BoundingBox} is an area of the bounding box, and number_of_users is the total number of users in the bounding box. The total number of users in the bounding box includes both individual users that are not already in a crowd and users that are already in a crowd. In one embodiment, a is ⅔.

The crowd analyzer 58 then creates a crowd for each individual user within the bounding box that is not already included in a crowd and sets the optimal inclusion distance for the crowds to the initial optimal inclusion distance (step 1716). At this point, the process proceeds to FIG. 16B where the crowd analyzer 58 analyzes the crowds relevant to the bounding box to determine whether any of the crowd members (i.e., users in the crowds) violate the optimal inclusion distance of their crowds (step 1718). Any crowd member that violates the optimal inclusion distance of his or her crowd is then removed from that crowd (step 1720). The crowd analyzer 58 then creates a crowd of one user for each of the users removed from their crowds in step 1720 and sets the optimal inclusion distance for the newly created crowds to the initial optimal inclusion distance (step 1722).

Next, the crowd analyzer 58 determines the two closest crowds for the bounding box (step 1724) and a distance between the two closest crowds (step 1726). The distance between the two closest crowds is the distance between the crowd centers of the two closest crowds. The crowd analyzer 58 then determines whether the distance between the two closest crowds is less than the optimal inclusion distance of a larger of the two closest crowds (step 1728). If the two closest crowds are of the same size (i.e., have the same number of users), then the optimal inclusion distance of either of the two closest crowds may be used. Alternatively, if the two closest crowds are of the same size, the optimal inclusion distances of both of the two closest crowds may be used such that the crowd analyzer 58 determines whether the distance between the two closest crowds is less than the optimal inclusion distances of both of the two closest crowds. As another alternative, if the two closest crowds are of the same size, the crowd analyzer 58 may compare the distance between the two closest crowds to an average of the optimal inclusion distances of the two closest crowds.

If the distance between the two closest crowds is less than the optimal inclusion distance, the two closest crowds are combined or merged (step 1730), and a new crowd center for the resulting crowd is computed (step 1732). Again, a center of mass algorithm may be used to compute the crowd center of a crowd. In addition, a new optimal inclusion distance for the resulting crowd is computed (step 1734). In one embodiment, the new optimal inclusion distance for the resulting crowd is computed as:

$$average = \frac{1}{n + 1} \cdot ( initial\_optimal \_inclusion \_dist + {\sum }_{i = 1}^{n} {d}_{i} ) , \\ optimial\_inclusion \_dist = average + \sqrt{( \frac{1}{n} \cdot {\sum }_{i = 1}^{n} {( {d}_{i} - average )}^{2} )} ,$$

where n is the number of users in the crowd and dᵢ is a distance between the ith user and the crowd center. In other words, the new optimal inclusion distance is computed as the average of the initial optimal inclusion distance and the distances between the users in the crowd and the crowd center plus one standard deviation.

At this point, the crowd analyzer 58 determines whether a maximum number of iterations have been performed (step 1736). The maximum number of iterations is a predefined number that ensures that the crowd formation process does not indefinitely loop over steps 1718 through 1734 or loop over steps 1718 through 1734 more than a desired maximum number of times. If the maximum number of iterations has not been reached, the process returns to step 1718 and is repeated until either the distance between the two closest crowds is not less than the optimal inclusion distance of the larger crowd or the maximum number of iterations has been reached. At that point, the crowd analyzer 58 discards crowds with less than three users, or members (step 1738) and the process ends.

Returning to step 1708 in FIG. 16A, if the new and old bounding boxes do not overlap, the process proceeds to FIG. 16C and the bounding box to be processed is set to the old bounding box (step 1740). In general, the crowd analyzer 58 then processes the old bounding box in much the same manner as described above with respect to steps 1712 through 1738. More specifically, the crowd analyzer 58 determines the individual users and crowds relevant to the bounding box (step 1742). The crowds relevant to the bounding box are crowds that are within or overlap the bounding box (e.g., have at least one user located within the bounding box). The individual users relevant to the bounding box are users that are currently located within the bounding box and not already part of a crowd. Next, the crowd analyzer 58 computes an optimal inclusion distance for individual users based on user density within the bounding box (step 1744). More specifically, in one embodiment, the optimal inclusion distance for individuals, which is also referred to herein as an initial optimal inclusion distance, is set according to the following equation:

$$initial\_optimal \_inclusion \_dist = a \cdot \sqrt{\frac{{A}_{BoundingBox}}{number\_of \_users}} ,$$

where a is a number between 0 and 1, A_{BoundingBox} is an area of the bounding box, and number_of_users is the total number of users in the bounding box. The total number of users in the bounding box includes both individual users that are not already in a crowd and users that are already in a crowd. In one embodiment, a is ⅔.

The crowd analyzer 58 then creates a crowd of one user for each individual user within the bounding box that is not already included in a crowd and sets the optimal inclusion distance for the crowds to the initial optimal inclusion distance (step 1746). At this point, the crowd analyzer 58 analyzes the crowds for the bounding box to determine whether any crowd members (i.e., users in the crowds) violate the optimal inclusion distance of their crowds (step 1748). Any crowd member that violates the optimal inclusion distance of his or her crowd is then removed from that crowd (step 1750). The crowd analyzer 58 then creates a crowd of one user for each of the users removed from their crowds in step 1750 and sets the optimal inclusion distance for the newly created crowds to the initial optimal inclusion distance (step 1752).

Next, the crowd analyzer 58 determines the two closest crowds in the bounding box (step 1754) and a distance between the two closest crowds (step 1756). The distance between the two closest crowds is the distance between the crowd centers of the two closest crowds. The crowd analyzer 58 then determines whether the distance between the two closest crowds is less than the optimal inclusion distance of a larger of the two closest crowds (step 1758). If the two closest crowds are of the same size (i.e., have the same number of users), then the optimal inclusion distance of either of the two closest crowds may be used. Alternatively, if the two closest crowds are of the same size, the optimal inclusion distances of both of the two closest crowds may be used such that the crowd analyzer 58 determines whether the distance between the two closest crowds is less than the optimal inclusion distances of both of the two closest crowds. As another alternative, if the two closest crowds are of the same size, the crowd analyzer 58 may compare the distance between the two closest crowds to an average of the optimal inclusion distances of the two closest crowds.

If the distance between the two closest crowds is less than the optimal inclusion distance, the two closest crowds are combined or merged (step 1760), and a new crowd center for the resulting crowd is computed (step 1762). Again, a center of mass algorithm may be used to compute the crowd center of a crowd. In addition, a new optimal inclusion distance for the resulting crowd is computed (step 1764). As discussed above, in one embodiment, the new optimal inclusion distance for the resulting crowd is computed as:

$$average = \frac{1}{n + 1} \cdot ( initial\_optimal \_inclusion \_dist + {\sum }_{i = 1}^{n} {d}_{i} ) , \\ optimial\_inclusion \_dist = average + \sqrt{( \frac{1}{n} \cdot {\sum }_{i = 1}^{n} {( {d}_{i} - average )}^{2} )} ,$$

where n is the number of users in the crowd and dᵢ is a distance between the ith user and the crowd center. In other words, the new optimal inclusion distance is computed as the average of the initial optimal inclusion distance and the distances between the users in the crowd and the crowd center plus one standard deviation.

At this point, the crowd analyzer 58 determines whether a maximum number of iterations have been performed (step 1766). If the maximum number of iterations has not been reached, the process returns to step 1748 and is repeated until either the distance between the two closest crowds is not less than the optimal inclusion distance of the larger crowd or the maximum number of iterations has been reached. At that point, the crowd analyzer 58 discards crowds with less than three users, or members (step 1768). The crowd analyzer 58 then determines whether the crowd formation process for the new and old bounding boxes is done (step 1770). In other words, the crowd analyzer 58 determines whether both the new and old bounding boxes have been processed. If not, the bounding box is set to the new bounding box (step 1772), and the process returns to step 1742 and is repeated for the new bounding box. Once both the new and old bounding box have been processed, the crowd formation process ends.

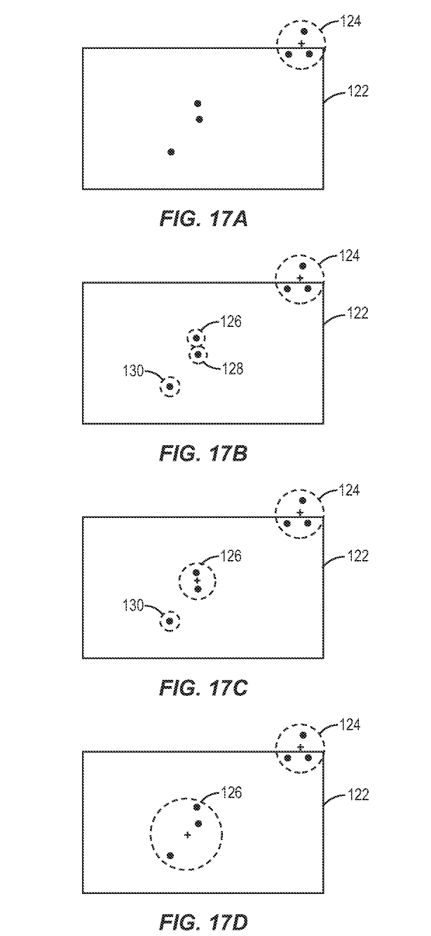

FIGS. 17A through 17D graphically illustrate the crowd formation process of FIGS. 16A through 16D for a scenario where the crowd formation process is triggered by a location update for a user having no old location. In this scenario, the crowd analyzer 58 creates a new bounding box 122 for the new location of the user, and the new bounding box 122 is set as the bounding box to be processed for crowd formation. Then, as illustrated in FIG. 17A, the crowd analyzer 58 identifies all individual users currently located within the bounding box 122 and all crowds located within or overlapping the bounding box 122. In this example, crowd 124 is an existing crowd relevant to the bounding box 122. Crowds are indicated by dashed circles, crowd centers are indicated by cross-hairs (+), and users are indicated as dots. Next, as illustrated in FIG. 17B, the crowd analyzer 58 creates crowds 126 through 130 of one user for the individual users, and the optional inclusion distances of the crowds 126 through 130 are set to the initial optimal inclusion distance. As discussed above, the initial optimal inclusion distance is computed by the crowd analyzer 58 based on a density of users within the bounding box 122.

The crowd analyzer 58 then identifies the two closest crowds 126 and 128 in the bounding box 122 and determines a distance between the two closest crowds 126 and 128. In this example, the distance between the two closest crowds 126 and 128 is less than the optimal inclusion distance. As such, the two closest crowds 126 and 128 are merged and a new crowd center and new optimal inclusion distance are computed, as illustrated in FIG. 17C. The crowd analyzer 58 then repeats the process such that the two closest crowds 126 and 130 in the bounding box 122 are again merged, as illustrated in FIG. 17D. At this point, the distance between the two closest crowds 124 and 126 is greater than the appropriate optimal inclusion distance. As such, the crowd formation process is complete.

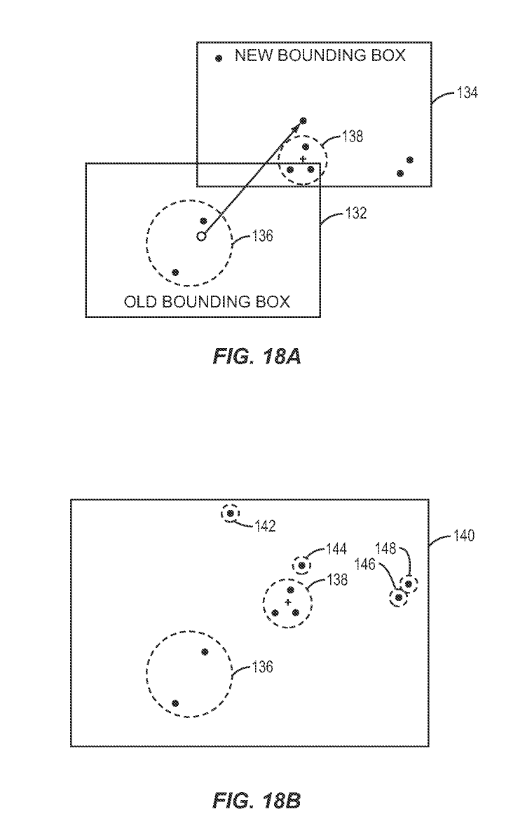

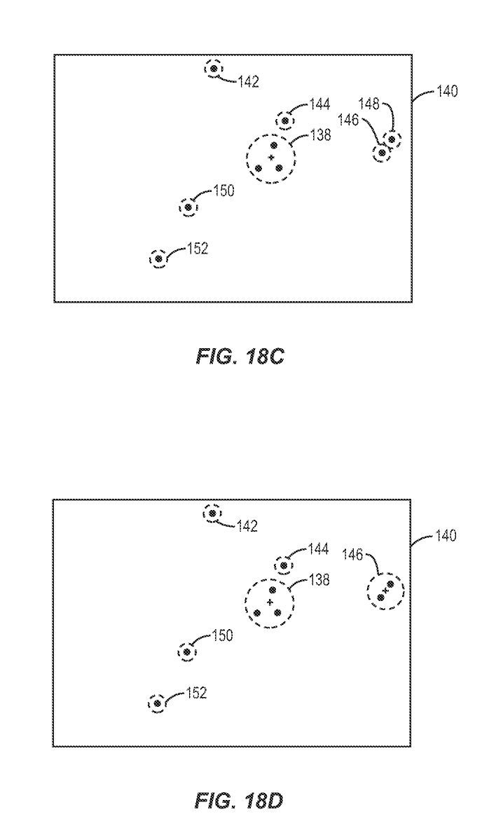

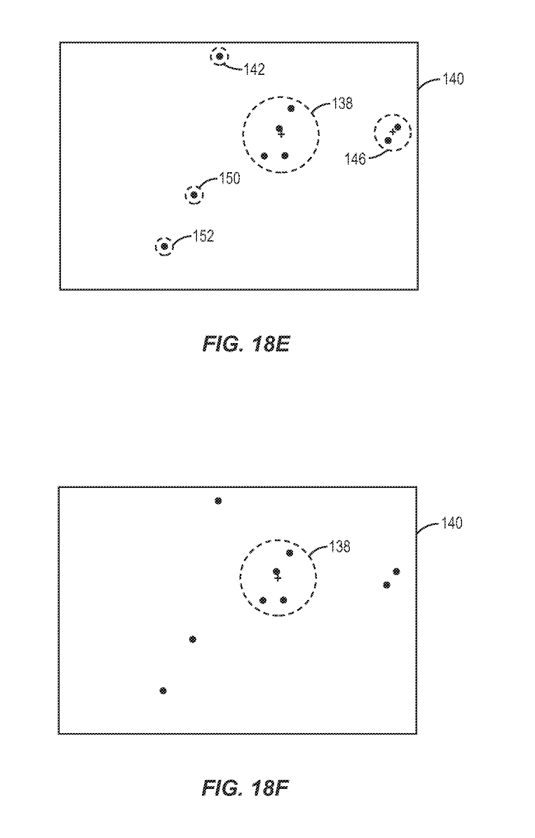

FIGS. 18A through 18F graphically illustrate the crowd formation process of FIGS. 16A through 16D for a scenario where the new and old bounding boxes overlap. As illustrated in FIG. 18A, a user moves from an old location to a new location, as indicated by an arrow. The crowd analyzer 58 receives a location update for the user giving the new location of the user. In response, the crowd analyzer 58 creates an old bounding box 132 for the old location of the user and a new bounding box 134 for the new location of the user. Crowd 136 exists in the old bounding box 132, and crowd 138 exists in the new bounding box 134.

Since the old bounding box 132 and the new bounding box 134 overlap, the crowd analyzer 58 creates a bounding box 140 that encompasses both the old bounding box 132 and the new bounding box 134, as illustrated in FIG. 18B. In addition, the crowd analyzer 58 creates crowds 142 through 148 for individual users currently located within the bounding box 140. The optimal inclusion distances of the crowds 142 through 148 are set to the initial optimal inclusion distance computed by the crowd analyzer 58 based on the density of users in the bounding box 140.

Next, the crowd analyzer 58 analyzes the crowds 136, 138, and 142 through 148 to determine whether any members of the crowds 136, 138, and 142 through 148 violate the optimal inclusion distances of the crowds 136, 138, and 142 through 148. In this example, as a result of the user leaving the crowd 136 and moving to his new location, both of the remaining members of the crowd 136 violate the optimal inclusion distance of the crowd 136. As such, the crowd analyzer 58 removes the remaining users from the crowd 136 and creates crowds 150 and 152 of one user each for those users, as illustrated in FIG. 18C.

The crowd analyzer 58 then identifies the two closest crowds in the bounding box 140, which in this example are the crowds 146 and 148. Next, the crowd analyzer 58 computes a distance between the two crowds 146 and 148. In this example, the distance between the two crowds 146 and 148 is less than the initial optimal inclusion distance and, as such, the two crowds 146 and 148 are combined. In this example, crowds are combined by merging the smaller crowd into the larger crowd. Since the two crowds 146 and 148 are of the same size, the crowd analyzer 58 merges the crowd 148 into the crowd 146, as illustrated in FIG. 18D. A new crowd center and new optimal inclusion distance are then computed for the crowd 146.

At this point, the crowd analyzer 58 repeats the process and determines that the crowds 138 and 144 are now the two closest crowds. In this example, the distance between the two crowds 138 and 144 is less than the optimal inclusion distance of the larger of the two crowds 138 and 144, which is the crowd 138. As such, the crowd 144 is merged into the crowd 138 and a new crowd center and optimal inclusion distance are computed for the crowd 138, as illustrated in FIG. 18E. At this point, there are no two crowds closer than the optimal inclusion distance of the larger of the two crowds. As such, the crowd analyzer 58 discards any crowds having less than three members, as illustrated in FIG. 18F. In this example, the crowds 142, 146, 150, and 152 have less than three members and are therefore removed. The crowd 138 has three or more members and, as such, is not removed. At this point, the crowd formation process is complete.

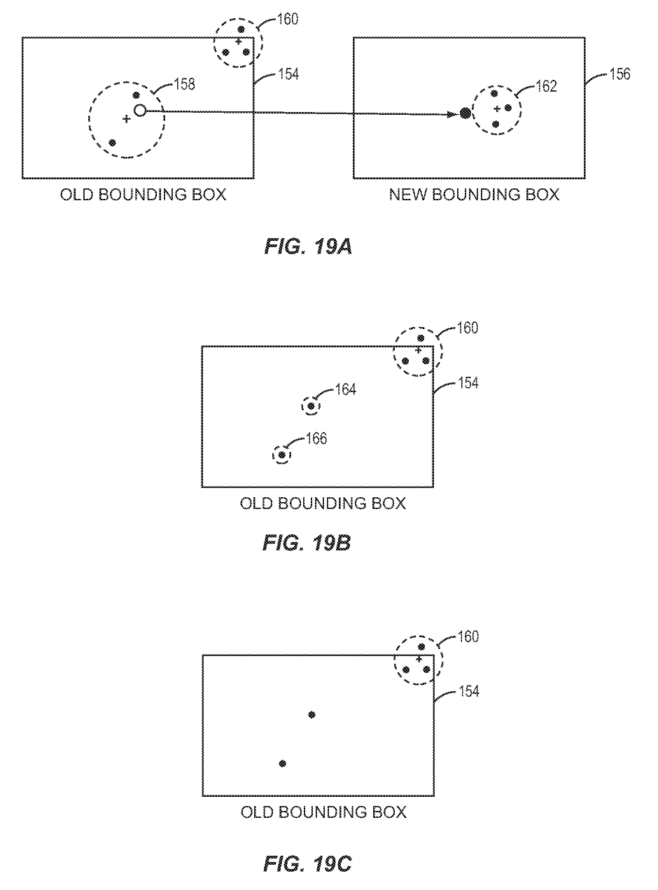

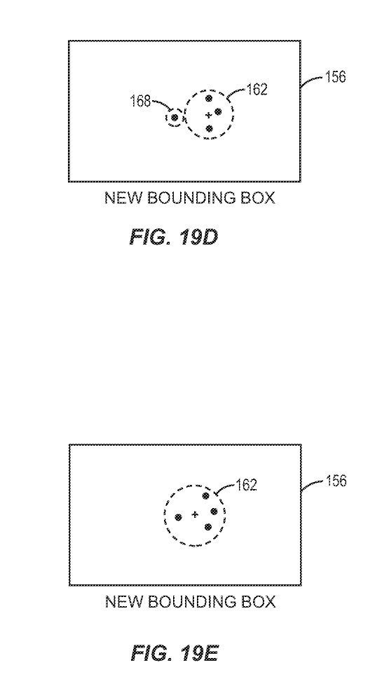

FIGS. 19A through 19E graphically illustrate the crowd formation process of FIGS. 16A through 16D in a scenario where the new and old bounding boxes do not overlap. As illustrated in FIG. 19A, in this example, the user moves from an old location to a new location. The crowd analyzer 58 creates an old bounding box 154 for the old location of the user and a new bounding box 156 for the new location of the user. Crowds 158 and 160 exist in the old bounding box 154, and crowd 162 exists in the new bounding box 156. In this example, since the old and new bounding boxes 154 and 156 do not overlap, the crowd analyzer 58 processes the old and new bounding boxes 154 and 156 separately.

More specifically, as illustrated in FIG. 19B, as a result of the movement of the user from the old location to the new location, the remaining users in the crowd 158 no longer satisfy the optimal inclusion distance for the crowd 158. As such, the remaining users in the crowd 158 are removed from the crowd 158, and crowds 164 and 166 of one user each are created for the removed users as shown in FIG. 19B. In this example, no two crowds in the old bounding box 154 are close enough to be combined. As such, processing of the old bounding box 154 is complete as illustrated in FIG. 19C, and the crowd analyzer 58 proceeds to process the new bounding box 156.

As illustrated in FIG. 19D, processing of the new bounding box 156 begins by the crowd analyzer 58 creating a crowd 168 of one user for the user. The crowd analyzer 58 then identifies the crowds 162 and 168 as the two closest crowds in the new bounding box 156 and determines a distance between the two crowds 162 and 168. In this example, the distance between the two crowds 162 and 168 is less than the optimal inclusion distance of the larger crowd, which is the crowd 162. As such, the crowd analyzer 58 combines the crowds 162 and 168 by merging the crowd 168 into the crowd 162, as illustrated in FIG. 19E. A new crowd center and new optimal inclusion distance are then computed for the crowd 162. At this point, the crowd formation process is complete.

FIG. 20 illustrates a process for creating a new crowd according to one embodiment of the present disclosure. In the preferred embodiment described herein, this process is performed by the new crowd engine 62 of the MAP server 12, but is not limited thereto. First, a new crowd request is received (step 1800). In one embodiment, the new crowd request is received from the user 20 of one of the mobile devices 18, where the new crowd request is initiated by the user 20 via, for example, the MAP application 32 of the mobile device 18. The new crowd request includes a crowd profile for the new crowd and location information regarding where the new crowd is to be formed. The crowd profile includes one or more interests, which are preferably expressed as keywords, for the new crowd and, in some embodiments, weights assigned to the interests. The location information directly or indirectly defines a geographic region in which the new crowd is to be formed, which is also referred to herein as a geographic bounding region for the new crowd request. For example, the location information may be a city, a postal zip code, a number of latitude and longitude coordinate pairs defining the geographic bounding region, a latitude and longitude pair and a distance/radius defining a circular geographic bounding region, or the like. In addition, the new crowd request may include one or more attributes for the new crowd and, in some embodiments, weights assigned to the different attributes for the new crowd. The one or more attributes may include, for example, a size of the new crowd (e.g., a minimum number of users in the new crowd and/or a maximum number of users in the new crowd). The one or more attributes for the new crowd may additionally or alternatively include a time of creation for the new crowd or a time window for the new crowd (e.g., a start time and a duration for the new crowd). Lastly, the new crowd request may include a list of one or more users explicitly identified as users to attract to the new crowd and/or crowds identified as crowds of users to attract to the new crowd.

Next, a POI at which to form the new crowd is selected based on the crowd profile for the new crowd, the location information regarding the geographic region in which the new crowd is to be formed, and, in some embodiments, the attributes for the new crowd (step 1802). The details of step 1802 are described below in detail. As described below, in one embodiment, a number of geographically relevant POIs are identified for the new crowd, and one or more potential POIs are selected from the geographically relevant POIs based on the crowd profile for the new crowd and, in some embodiments, the attributes for the new crowd. The geographically relevant POIs are POIs located within the geographic bounding region in which the new crowd is to be formed. The one or more potential POIs are then returned to the user 20 that initiated the new crowd request, and the user 20 is enabled to select the POI at which the new crowd is to be formed from the one or more potential POIs. In another embodiment, a number of geographically relevant POIs are identified for the new crowd, and a POI at which to form the new crowd is automatically and programmatically selected from the geographically relevant POIs based on the crowd profile for the new crowd and, in some embodiments, the attributes for the new crowd.

Next, users to attract to the new crowd at the selected POI are selected (step 1804). Once the users to attract to the new crowd at the selected POI are selected, the selected users are attracted to the new crowd at the selected POI (step 1806). In one embodiment, the selected users are attracted to the new crowd via alerts issued to the mobile devices 18 of the users 20 using an alert mechanism of the MAP server 12. Note that the users 20 may configure when they are to receive such alerts. For example, the users 20 may configure settings such that they never receive such alerts, always receive such alerts, receive such alerts only after 5 pm on weekdays and anytime on weekends, or the like. In another embodiment, the MAP server 12 may utilize a new crowd, even before it is formed, to serve requests for crowd data from the mobile devices 18. In this manner, the users 20 may be made aware of the new crowd and choose to join the new crowd by going to the POI selected for the new crowd if they so choose. In the another embodiment, the selected users are attracted to the new crowd at the selected POI by sending an invitation to the selected users to join the new crowd. The invitation includes information regarding the new crowd such as the POI at which the new crowd is to be formed, the crowd profile of the new crowd, and a time window during which the new crowd is to be formed (e.g., the time of creation of the new crowd and a duration of the new crowd). The invitation may be sent to the selected user via text-messaging, Instant Messaging (IM), e-mail messages, or the like, where any information needed to send the invitation (e.g., mobile telephone number, IM user name, or e-mail address) is stored in the user records of the selected users maintained by the MAP server 12.

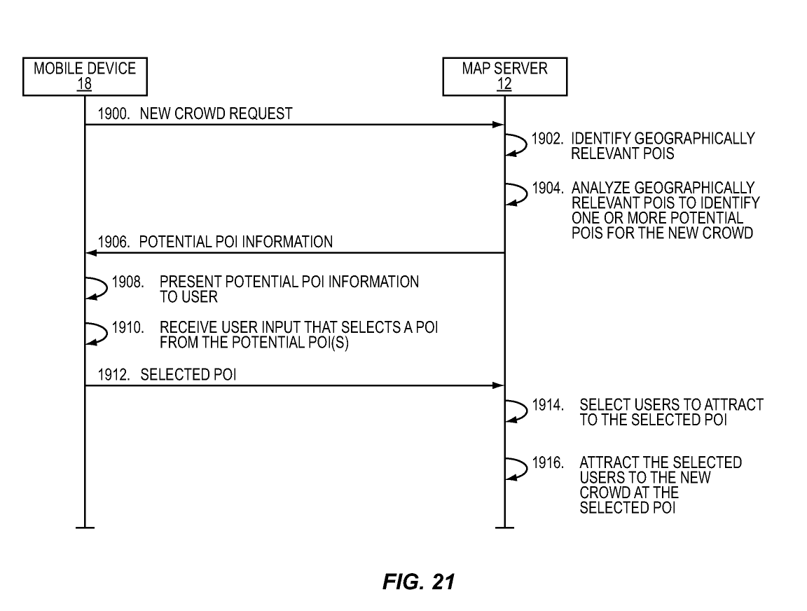

FIG. 21 illustrates the operation of the system 10 to form new crowds according to one embodiment of the present disclosure. First, one of the mobile devices 18 sends a new crowd request to the MAP server 12 (step 1900). Note that while the new crowd request originates from the mobile device 18 in this embodiment, the present disclosure is not limited thereto. The new crowd request may alternatively originate from a device, other than the mobile device 18, of the user 20, from the subscriber device 22, from the third-party service 26, or the like. As discussed above, the new crowd request includes a crowd profile for the new crowd and location information defining a bounding region for the new crowd request (i.e., a geographic bounding region in which the new crowd is to be formed). The crowd profile of the new crowd includes one or more interests, which are preferably expressed as keywords, for the new crowd and, in some embodiments, weights assigned to the interests. In addition, the new crowd request may include one or more attributes for the new crowd and, in some embodiments, weights assigned to the different attributes for the new crowd. The one or more attributes may include, for example, a size of the new crowd (e.g., a minimum number of users in the new crowd and/or a maximum number of users in the new crowd). The one or more attributes for the new crowd may additionally or alternatively include a time of creation for the new crowd or a time window for the new crowd (e.g., a start time and a duration for the new crowd). Lastly, the new crowd request may include a list of one or more users explicitly identified as users to attract to the new crowd and/or crowds identified as crowds of users to attract to the new crowd.

In response to the new crowd request, the new crowd engine 62 of the MAP server 12 identifies one or more POIs that are geographically relevant to the bounding region defined for the new crowd request, which are referred to herein as one or more geographically relevant POIs (step 1902). The geographically relevant POIs are POIs that are located within the bounding region for the new crowd request. The new crowd engine 62 identifies the geographically relevant POIs by querying the crowd analyzer 58. In one embodiment, the crowd analyzer 58 reactively performs a crowd formation process, such as the crowd formation process of FIG. 14, for the bounding region of the new crowd request, thereby identifying the geographically relevant POIs. In another embodiment, the crowd analyzer 58 performs a proactive crowd formation process, such as the crowd formation process of FIGS. 16A through 16D. In this case, crowds have already been formed, and the crowd analyzer 58 queries the datastore 66 of the MAP server 12 to identify crowds that are currently located within the bounding region for the new crowd request.

Next, the new crowd engine 62 analyzes the geographically relevant POIs based on associated historical aggregate profile data and/or associated current crowd data to identify one or more potential POIs for the new crowd (step 1904). The one or more potential POIs identified for the new crowd are then returned to the mobile device 18 (step 1906) where the one or more potential POIs and, optionally, information regarding the one or more potential POIs are presented to the user 20 of the mobile device 18 (step 1908). The information regarding the one or more potential POIs may include information resulting from the analysis of step 1904 that assists the user 20 in selecting the POI for the new crowd from the one or more potential POIs. For example, the information regarding the one or more potential POIs may include ratings determined for the one or more potential POIs that are indicative of a degree to which the potential POIs match the crowd profile and attributes defined for the new crowd. In addition or alternatively, the information regarding the one or more potential POIs may include historical aggregate profile data and/or current crowd data for the one or more potential POIs, sizes of crowds currently and/or historically located at the one or more potential POIs, an indication of whether the one or more potential POIs are resistant to changes in crowds, an indication of whether users have successfully been attracted to the one or more potential POIs for new crowds in the past, or the like. User input is received from the user 20 of the mobile device 18 that selects a POI for the new crowd from the one or more potential POIs (step 1910). The mobile device 18 then returns the selected POI to the MAP server 12 (step 1912).

In response to receiving the selected POI from the mobile device 18, the new crowd engine 62 of the MAP server 12 selects users to attract to the new crowd at the selected POI (step 1914). Once the POI and the users to attract to the new crowd are selected, the new crowd engine 62 attracts the selected users to the new crowd at the selected POI (step 1916). In one embodiment, the selected users to attract to the new crowd include one or more of the following:
users currently located at the selected POI that have user profiles that sufficiently match the crowd profile of the new crowd;
users currently located near the selected POI (e.g., within a predetermined static or dynamic maximum distance from the POI) that have user profiles that sufficiently match the crowd profile of the new crowd;
users in crowds where the crowds are currently located at the selected POI and the aggregate profiles of the crowds sufficiently match the crowd profile of the new crowd;
users in crowds where the crowds are currently located near the selected POI (e.g., the crowd centers of the crowds are within a predetermined static or dynamic maximum distance from the POI) and the aggregate profiles of the crowds sufficiently match the crowd profile of the new crowd;
users in or near crowds at the selected POI that have user profiles that more closely match the crowd profile of the new crowd than the aggregate profile of the crowds in which they are currently located;
users in or near crowds near the selected POI that have user profiles that more closely match the crowd profile of the new crowd than the aggregate profile of the crowds in which they are currently located;
users currently located near the selected POI or in crowds currently located near the selected POI that have user profiles that more closely match the crowd profile of the new crowd than a historical aggregate profile for their current locations;
users that recently left crowds at or near the selected POI that have user profiles that sufficiently match the crowd profile of the new crowd;
users in crowds currently located near the selected POI that sufficiently match the crowd profile of the new crowd and that are at locations for which there is little to no historical data or for which the historical aggregate profile data is not continuous or consistent; and
users in crowds having less than a predefined maximum number of users (e.g., 5) that are located near the selected POI and have aggregate profiles that sufficiently match the crowd profile of the new crowd.
   It should be noted that as used herein one profile “sufficiently matches” another profile when the two profiles match at least to a threshold degree (e.g., at least 70% of the interests in one profile must match interests in the other profile). Also, the predetermined distance from the POI may be a predefined static distance or a dynamically determined distance based on, for example, current, historical, and/or predicted data, as applicable. For example, the maximum distance from the POI in order to be considered near the POI may be dynamically determined based on how successful the system has been at attracting new users or crowds to the POI in the past, to similar POIs in the past, or to other POIs in the same geographic region in the past. As another example, the maximum distance from the POI may be based on an amount of time that the system has to create the new crowd (e.g., the shorter the amount of time the larger the maximum distance). For example, if the POI is in a small town, the maximum distance may be greater than if the POI were in a large city. As another example, in the past, the system may have had success attracting users to a POI from a nearby town and, as such, the system may increase the maximum distance from the POI to include that nearby town and, possibly, other nearby towns.

In addition or alternatively, the MAP server 12 may provide crowd tracking where the locations of crowds and user profile data of the users in the crowds are tracked over time. For instance, for a particular crowd, crowd snapshots may be captured for the crowd over time, where each crowd snapshot includes the location of the crowd (e.g., a crowd center of the crowd and/or locations of the northwest most and southeast most users in the crowd) and user profile data (e.g., anonymized user profiles) for users in the crowd at the time of capturing the crowd snapshot. Using such crowd tracking information, the selected users to attract to the new crowd may additionally or alternatively include one or more of the following:
users currently in crowds that have historically been located at the selected POI where the crowds have aggregate profiles that sufficiently match the crowd profile of the new crowd;
users currently in crowds that have historically been located near the selected POI where the crowds have aggregate profiles that sufficiently match the crowd profile of the new crowd;
users currently in crowds that are predicted to be located at the selected POI at the time of creation of the new crowd, near the time of creation of the new crowd, or during the time window for the new crowd; and
users currently in crowds that are predicted to be located near the selected POI at the time of creation of the new crowd, near the time of creation of the new crowd, or during the time window for the new crowd.
   The future locations of crowds may be predicted based on the crowd tracking information using any suitable prediction algorithm. For example, the crowd tracking information may be analyzed to determine the locations of the crowd during previous time windows that correspond to the time window of the new crowd. For example, if the new crowd is to be created during the time window of today (Thursday) from 9 pm-12 pm, the crowd tracking information may be used to determine which crowds have historically been located at the selected POI on previous Thursdays (e.g., Thursdays over the past month) from 9 pm-12 pm. Those crowds may then be predicted to be at the selected POI today (Thursday) from 9 pm-12 pm.

In addition or alternatively, while only the current locations of the users 20 are preferably stored by the MAP server 12, the MAP server 12 may alternatively store location histories for the users 20. Using the location histories of the users 20, the selected users to attract to the new crowd may additionally or alternatively include one or more of the following:
users that have historically been located at the selected POI and have user profiles that sufficiently match the crowd profile of the new crowd;
users that have historically been located near the selected POI and have user profiles that sufficiently match the crowd profile of the new crowd;
users predicted to be located at the selected POI at the time of creation of the new crowd, near the time of creation of the new crowd, or during the time window for the new crowd based on the location histories of those users; and
users predicted to be located near the selected POI at the time of creation of the new crowd, near the time of creation of the new crowd, or during the time window for the new crowd based on the location histories of those users.

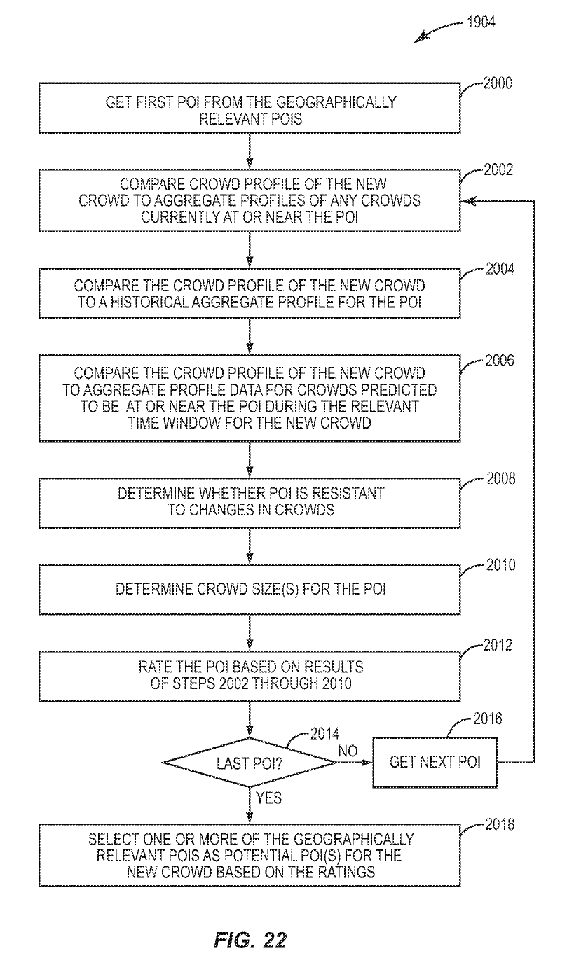

FIG. 22 illustrates step 1904 of FIG. 21 in more detail according to one embodiment of the present disclosure. In order to identify the one or more potential POIs for the new crowd, the new crowd engine 62 of the MAP server 12 gets, or obtains, the first POI from the geographically relevant POIs identified in step 1902 of FIG. 21 (step 2000). The POI is analyzed by comparing various information regarding the POI to the crowd profile and attributes of the new crowd. More specifically, in one embodiment, the new crowd engine 62 compares the crowd profile of the new crowd to aggregate profiles of any crowds at, and in some embodiments, near the POI (step 2002). The aggregate profiles of the crowds are generated by the aggregation engine 60. In one embodiment, for each crowd, the aggregate profile of the crowd includes a number of instances, or user matches, for the interests included in the user profiles of the users 20 in the crowd and, optionally, a number of users 20 in the crowd. More specifically, the user profiles of the users 20 in the crowd are compared to one another to determine a number of user matches for interests included in the user profiles of the users 20 in the crowd. Therefore, for example, if the interest “Sports” is found in the user profiles of five (5) users in the crowd, then the aggregate profile for the crowd includes data indicating that there are five (5) user matches for the interest “Sports” in the crowd. In another embodiment, the aggregate profile includes a ratio of the number of user matches to the total number of users in the crowd for the interests included in the user profiles of the users 20 in the crowd. Thus, if there are ten (10) users in the crowd and the interest “Sports” is found in the user profiles of five (5) of the users in the crowd, then the aggregate profile for the crowd may include the ratio of 1/2 for the interest “Sports.”

The new crowd engine 62 then compares the aggregate profiles of the crowds currently at or near the POI to the crowd profile of the new crowd to determine, for example, a total number of user matches or a total ratio of user matches for each interest in the crowd profile among the crowds currently at or near the POI. For example, if the crowd profile includes the interest of “Hiking,” the new crowd engine 62 may sum the number of user matches for the interest “Hiking” for all of the crowds currently at or near the POI to provide a total number of user matches for the interest “Hiking” or sum the ratio of user matches to total number of users for the interest “Hiking” for all of the crowds currently at or near the POI to provide a total ratio of user matches to total number of users for the interest “Hiking.” In addition, in this embodiment, the new crowd engine 62 combines the total number of user matches (or total ratio of user matches to total number of users) for each of the interests in the crowd profile according to predefined weights assigned to the interests in the crowd profile to provide a corresponding score (SCORE_{CURRENT}) for the POI which represents a degree to which the aggregate profiles of the crowds currently at or near the POI match the crowd profile of the new crowd. For example, the score (SCORE_{CURRENT}) may be computed as:

$${SCORE}_{CURRENT} = \frac{{\sum }_{i = 1}^{n} {w}_{i} \cdot {TotalNumberOfUserMatches}_{CURRENT , i}}{{\sum }_{i = 1}^{n} {w}_{i}} ,$$

where n is a number of interests in the crowd profile of the new crowd, wᵢ is a predefined weight assigned to the i-th interest in the crowd profile of the new crowd, and TotalNumberOfUserMatches_{CURRENT,i} is the total number of user matches across all of the crowds at or near the POI for the i-th interest in the crowd profile of the new crowd.

In a similar manner, the new crowd engine 62 compares the crowd profile of the new crowd to a historical aggregate profile for the POI (step 2004). More specifically, in one embodiment, the history manager 56 and the aggregation engine 60 of the MAP server 12 operate to obtain a number of history objects stored for one or more geographical areas encompassing the POI. Optionally, a time window may be utilized such that only those history objects created during the time window are obtained. The time window may be system-defined or user-defined. For example, the time window may be a relative time window such as, but not limited to, the last week or the last month. Once the history objects are obtained, the user profile data stored in the history objects is aggregated to provide the historical aggregate profile for the POI. The historical aggregate profile may include a number of user matches for each interest in the user profiles stored in the history objects and, optionally, a total number of users represented in the history objects. The historical aggregate profile may alternatively include a ratio of the number of user matches to the total number of users represented in the history objects for each interest in the user profile stored in the history objects. The historical aggregate profile of the POI is then compared to the crowd profile to determine, for each interest in the crowd profile, the number of user matches in the history objects for the interest or a ratio of the number of user matches to the total number of users for the interest. A score (SCORE_{HISTORICAL}) representing a degree to which the historical aggregate profile for the POI matches the crowd profile for the new crowd is then preferably generated by combining the numbers of user matches or ratios for the interests in the crowd profile according to predefined weights assigned to the interests in the crowd profile. For example, the score (SCORE_{HISTORICAL}) may be computed as:

$${SCORE}_{HISTORICAL} = \frac{{\sum }_{i = 1}^{n} {w}_{i} \cdot {TotalNumberOfUserMatches}_{HISTORICAL , i}}{{\sum }_{i = 1}^{n} {w}_{i}} ,$$

where n is a number of interests in the crowd profile of the new crowd, wᵢ is a predefined weight assigned to the i-th interest in the crowd profile of the new crowd, and TotalNumberOfUserMatches_{HISTORICAL,i} is the total number of user matches across all of the user profiles stored in the history objects for the i-th interest in the crowd profile of the new crowd.

Note that, in one exemplary alternative embodiment, rather than comparing the crowd profile of the new crowd to the historical aggregate profile of the POI, the crowd profile of the new crowd may be compared directly to the user profile data stored in the history objects obtained for the POI. In this case, data resulting from the comparison may include, for each interest in the crowd profile of the new crowd, either a number of user matches for the interest or a ratio of the number of user matches for the interest to the total number of users represented by the history objects. A score (SCORE_{HISTORICAL}) representing the degree of similarity between the crowd profile and user profiles of users historically located at the POI may then be computed as a weighted average of the number of user matches or ratio. As an example, the score (SCORE_{HISTORICAL}) may be computed using the same equation for the score (SCORE_{HISTORICAL}) described above.

The new crowd engine 62 also compares the crowd profile of the new crowd to aggregate profiles of crowds predicted to be at or near the POI during the relevant time window for the new crowd (step 2006). As discussed above, in one embodiment, the crowd analyzer 58 tracks crowds. In this case, the new crowd engine 62 may query the datastore 66 to identify crowd snapshots of crowds located at or near the POI in the past during a time window that corresponds to the relevant time window for the new crowd. For example, if the relevant time window for the new crowd is today (Thursday) from 9 pm-12 pm, then corresponding time windows in the past may be, for instance, previous Thursdays from 9 pm-12 pm, previous days from 9 pm-12 pm, or the like. In one embodiment, a crowd is identified as a crowd predicted to be located at or near the POI during the relevant time window for the new crowd if the crowd has previously been located at or near the POI at least a predefined threshold number of times or a predefined threshold amount of time in the past, as indicated by corresponding crowd snapshots for the crowd. Aggregate profiles are obtained for the crowds predicted to be at or near the POI during the relevant time window for the new crowd based on the user profiles of the users 20 that are currently in the crowd and, optionally, user profiles of the users 20 previously in the crowd. The aggregate profiles of the crowds are compared to the crowd profile of the new crowd in a manner similar to that described above. As a result, in one embodiment, a number of user matches or a ratio of the number of user matches to total number of users is determined for each interest in the crowd profile of the new crowd. Preferably, a score (SCORE_{PREDICTED}) that reflects the degree of similarity between the crowd profile of the new crowd and the aggregate profiles of the crowds predicted to be at or near the POI during the relevant time window for the new crowd is then generated based on the aforementioned values. For example, the score (SCORE_{PREDICTED}) may be computed as:

$${SCORE}_{PREDICTED} = \frac{{\sum }_{i = 1}^{n} {w}_{i} \cdot {TotalNumberOfUserMatches}_{PREDICTED , i}}{{\sum }_{i = 1}^{n} {w}_{i}} ,$$

where n is a number of interests in the crowd profile of the new crowd, wᵢ is a predefined weight assigned to the i-th interest in the crowd profile of the new crowd, and TotalNumberOfUserMatches_{PREDICTED,i} is the total number of user matches across all of the user profiles of all of the crowds predicted to be at or near the POI during the relevant time window for the new crowd for the i-th interest in the crowd profile of the new crowd.

The new crowd engine 62 also determines whether the POI is resistant to changes in crowds (step 2008). More specifically, the new crowd engine 62 may analyze the historical data in the history objects stored for the POI and/or crowd tracking data to determine how resistant the POI is to changes in crowds. Specifically, the new crowd engine 62 may analyze the historical data for the POI to determine whether the aggregate profile data is, for example, substantially static in terms of aggregate profile and/or number of users after a particular threshold number of users is at the POI. The new crowd engine 62 may also determine a crowd size or range of crowd sizes that can be accommodated at the POI (step 2010). For example, in one embodiment, the new crowd engine 62 may analyze the historical data stored for the POI or the crowd snapshots for crowds previously located at the POI to determine statistical information regarding the crowd size of crowds located at the POI such as, for example, an average crowd size, a minimum and/or maximum crowd size, or the like. In a similar manner, the new crowd engine 62 may analyze the historical data for the POI to determine the hours of operation of the POI. For example, if no data is recorded for the POI after 11 pm, the new crowd engine 62 may determine that the POI closes at 11 pm.

Next, the new crowd engine 62 rates the POI based on the results of steps 2002 through 2010 (step 2012). In this embodiment, the new crowd engine 62 combines the scores generated in step 2002 through 2006 to provide a combined score. The combined score may be, for example, an average or weighted average of the scores (SCORE_{CURRENT}, SCORE_{HISTORICAL}, and SCORE_{PREDICTED}). The combined score is then either incremented or decremented by a predefined value if the POI is resistant to changes in crowd profiles (depending on whether resistivity to changes in crowd profiles is or is not desired at the POI for the new crowd), incremented by a predefined value if the POI accommodates a desired crowd size for the new crowd, and, in some embodiments, either incremented or decremented based on whether the hours of operation of the POI include the relevant time window for the new crowd, thereby providing the rating of the POI.

The new crowd engine 62 then determines whether the last geographically relevant POI has been processed (step 2014). If not, the new crowd engine 62 gets the next POI from the geographically relevant POIs (step 2016) and the process returns to step 2002 and is repeated. Once all of the geographically relevant POIs have been processed, the new crowd engine 62 selects the one or more potential POIs for the new crowd from the geographically relevant POIs based on the ratings determined for the geographically relevant POIs (step 2018). For example, the new crowd engine 62 may select a predefined number of the geographically relevant POIs having the highest ratings as the one or more potential POIs for the new crowd. As another example, the new crowd engine 62 may select the geographically relevant POIs having ratings above a predefined threshold as the one or more potential POIs for the new crowd.

Before proceeding, it should be noted that steps 2002 through 2010 are exemplary steps to be performed to analyze the geographically relevant POIs. Not all of the steps 2002 through 2010 are required in all embodiments. For example, the geographically relevant POIs may be analyzed using any number of one or more of the steps 2002 through 2010. Further, there may be additional steps in the analysis of the geographically relevant POIs that are not illustrated. For example, the ratings of the geographically relevant POIs may also be based on whether users have successfully been attracted to the geographically relevant POIs for new crowds in the past. As another example, the ratings of the geographically relevant POIs may also be based on whether new crowds are already being formed at the geographically relevant POIs and, if so, the number of new crowds already being formed at the geographically relevant POIs. For instance, for a particular geographically relevant POI, the rating of that POI may also be based on whether any new crowds are already being formed at that POI and, if so, the number of new crowds already being formed at that POI. The rating of the POI may also take into account whether any new crowds are already being formed at other geographically relevant POIs that are near the POI (e.g., within a predefined distance from the POI). Thus, if one or more new crowds are already being formed at one of the geographically relevant POIs (and/or at another nearby geographically relevant POI), then the rating of that POI may be reduced. For example, if a new crowd that is large is already being formed at the geographically relevant POI, then there may not be a very good chance that another new large crowd can be formed at the POI in which case the rating of the POI is reduced. In contrast, if another new crowd that is similar to the new crowd desired to be created is already being created at the POI, then the rating of POI may be increased because it is more likely that the desired new crowd can be created at the POI. As a final example, if one or more large new crowds are already being formed at the POI, then the rating of the POI may be reduced if the POI is unable to accommodate another new crowd.

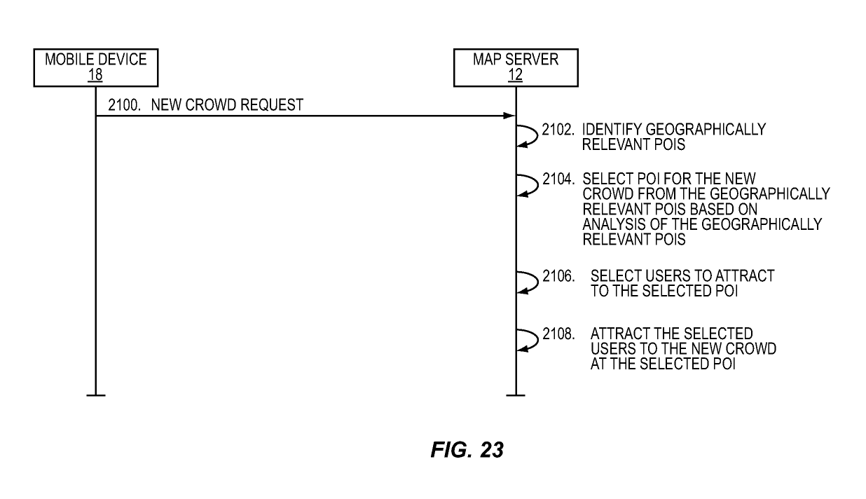

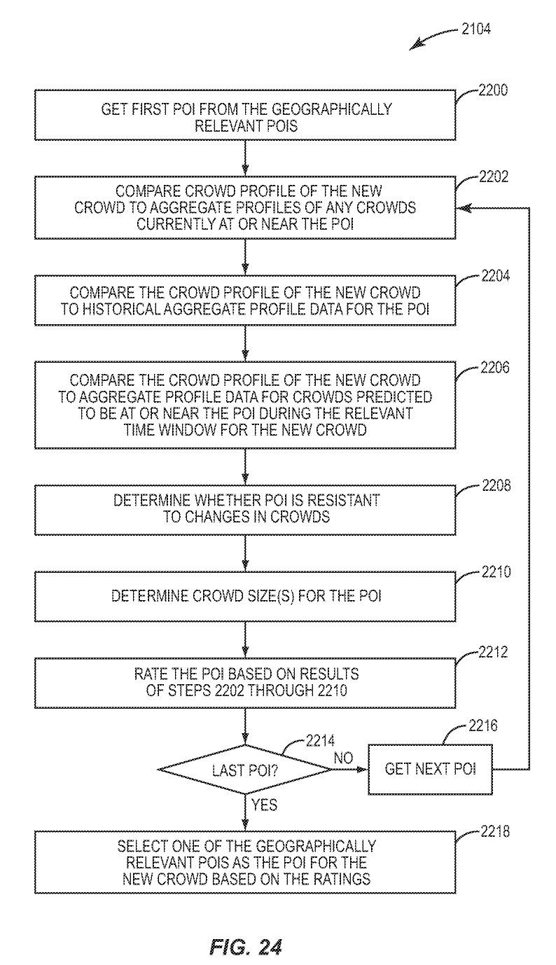

FIGS. 23 and 24 illustrate the operation of the system 10 to form new crowds according to another embodiment that is substantially the same as that described above with respect to FIGS. 21 and 22. However, in the embodiment of FIGS. 23 and 24, the new crowd engine 62 of the MAP server 12 automatically and programmatically selects the POI for the new crowd without user input (i.e., without user input selecting one of the potential POIs as the POI for the new crowd). More specifically, FIG. 23 illustrates the operation of the system 10 to form new crowds according to another embodiment of the present disclosure. First, one of the mobile devices 18 sends a new crowd request to the MAP server 12 (step 2100). In response to the new crowd request, the new crowd engine 62 of the MAP server 12 identifies one or more POIs that are geographically relevant to the bounding region defined for the new crowd request, which are referred to herein as one or more geographically relevant POIs (step 2102).

Next, the new crowd engine 62 selects a POI for the new crowd from the geographically relevant POIs identified in step 2102 based on an analysis of the geographically relevant POIs (step 2104). The new crowd engine 62 selects the POI for the new crowd automatically and programmatically without user input from a user (i.e., the user 20 of the mobile device 18) selecting the POI for the new crowd from a number of potential POIs for the new crowd. The new crowd engine 62 of the MAP server 12 then selects users to attract to the new crowd at the selected POI, as described above (step 2106). Once the POI and the users to attract to the new crowd are selected, the new crowd engine 62 attracts the selected users to the new crowd at the selected POI (step 2108).

FIG. 24 illustrates step 2104 of FIG. 23 in more detail according to one exemplary embodiment of the present disclosure. This process is substantially the same as that described above with respect FIG. 22. Notably, steps 2200 through 2216 are the same as steps 2000 through 2016 of FIG. 22. Once all of the geographically relevant POIs have been processed, the new crowd engine 62 selects the POI for the new crowd from the geographically relevant POIs based on the ratings determined for the geographically relevant POIs (step 2218). In one embodiment, the new crowd engine 62 selects the geographically relevant POI having the highest rating as the POI for the new crowd.

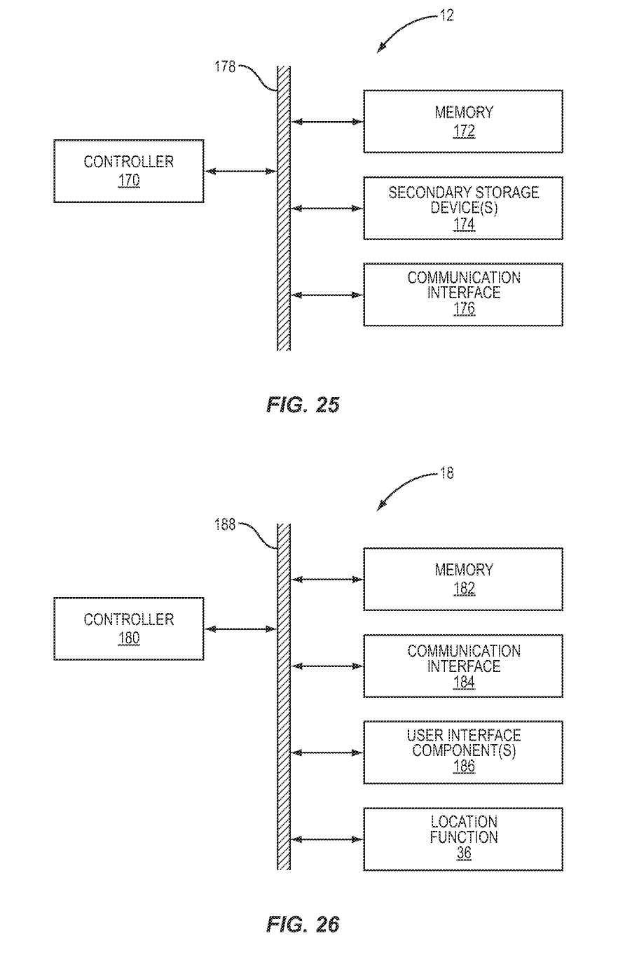

FIG. 25 is a block diagram of the MAP server 12 according to one embodiment of the present disclosure. As illustrated, the MAP server 12 includes a controller 170 connected to memory 172, one or more secondary storage devices 174, and a communication interface 176 by a bus 178 or similar mechanism. The controller 170 is a microprocessor, digital Application Specific Integrated Circuit (ASIC), Field Programmable Gate Array (FPGA), or the like. In this embodiment, the controller 170 is a microprocessor, and the application layer 40, the business logic layer 42, and the object mapping layer 64 (FIG. 2) are implemented in software and stored in the memory 172 for execution by the controller 170. Further, the datastore 66 (FIG. 2) may be implemented in the one or more secondary storage devices 174. The secondary storage devices 174 are digital data storage devices such as, for example, one or more hard disk drives. The communication interface 176 is a wired or wireless communication interface that communicatively couples the MAP server 12 to the network 28 (FIG. 1). For example, the communication interface 176 may be an Ethernet interface, local wireless interface such as a wireless interface operating according to one of the suite of IEEE 802.11 standards, or the like.

FIG. 26 is a block diagram of one of the mobile devices 18 according to one embodiment of the present disclosure. As illustrated, the mobile device 18 includes a controller 180 connected to memory 182, a communication interface 184, one or more user interface components 186, and the location function 36 by a bus 188 or similar mechanism. The controller 180 is a microprocessor, digital ASIC, FPGA, or the like. In this embodiment, the controller 180 is a microprocessor, and the MAP client 30, the MAP application 32, and the third-party applications 34 are implemented in software and stored in the memory 182 for execution by the controller 180. In this embodiment, the location function 36 is a hardware component such as, for example, a GPS receiver. The communication interface 184 is a wireless communication interface that communicatively couples the mobile device 18 to the network 28 (FIG. 1). For example, the communication interface 184 may be a local wireless interface such as a wireless interface operating according to one of the suite of IEEE 802.11 standards, a mobile communications interface such as a cellular telecommunications interface, or the like. The one or more user interface components 186 include, for example, a touchscreen, a display, one or more user input components (e.g., a keypad), a speaker, or the like, or any combination thereof.

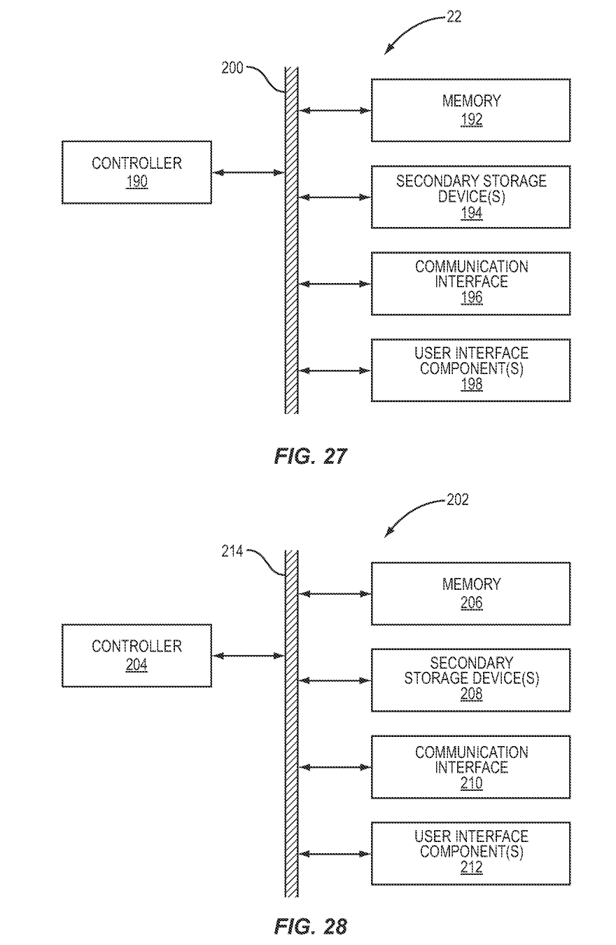

FIG. 27 is a block diagram of the subscriber device 22 according to one embodiment of the present disclosure. As illustrated, the subscriber device 22 includes a controller 190 connected to memory 192, one or more secondary storage devices 194, a communication interface 196, and one or more user interface components 198 by a bus 200 or similar mechanism. The controller 190 is a microprocessor, digital ASIC, FPGA, or the like. In this embodiment, the controller 190 is a microprocessor, and the web browser 38 (FIG. 1) is implemented in software and stored in the memory 192 for execution by the controller 190. The one or more secondary storage devices 194 are digital storage devices such as, for example, one or more hard disk drives. The communication interface 196 is a wired or wireless communication interface that communicatively couples the subscriber device 22 to the network 28 (FIG. 1). For example, the communication interface 196 may be an Ethernet interface, local wireless interface such as a wireless interface operating according to one of the suite of IEEE 802.11 standards, a mobile communications interface such as a cellular telecommunications interface, or the like. The one or more user interface components 198 include, for example, a touchscreen, a display, one or more user input components (e.g., a keypad), a speaker, or the like, or any combination thereof.

FIG. 28 is a block diagram of a computing device 202 operating to host the third-party service 26 according to one embodiment of the present disclosure. The computing device 202 may be, for example, a physical server. As illustrated, the computing device 202 includes a controller 204 connected to memory 206, one or more secondary storage devices 208, a communication interface 210, and one or more user interface components 212 by a bus 214 or similar mechanism. The controller 204 is a microprocessor, digital ASIC, FPGA, or the like. In this embodiment, the controller 204 is a microprocessor, and the third-party service 26 is implemented in software and stored in the memory 206 for execution by the controller 204. The one or more secondary storage devices 208 are digital storage devices such as, for example, one or more hard disk drives. The communication interface 210 is a wired or wireless communication interface that communicatively couples the computing device 202 to the network 28 (FIG. 1). For example, the communication interface 210 may be an Ethernet interface, local wireless interface such as a wireless interface operating according to one of the suite of IEEE 802.11 standards, a mobile communications interface such as a cellular telecommunications interface, or the like. The one or more user interface components 212 include, for example, a touchscreen, a display, one or more user input components (e.g., a keypad), a speaker, or the like, or any combination thereof.

The systems and methods described herein have substantial opportunity for variation without departing from the spirit or scope of the present disclosure. For instance, while FIGS. 22 and 24 illustrate exemplary processes for identifying potential POIs for a new crowd and selecting a POI for a new crowd, respectively, the processes illustrated therein have substantial opportunity for variation. For example, the users that may be attracted to the new crowd may first be determined for each geographically relevant POI. Then, the geographically relevant POIs may be analyzed based on the number of users that may be attracted to the geographically relevant POIs in addition to or as an alternative to the other analysis steps described in FIGS. 22 and 24.

As another example, the POI for the new crowd may be selected in advance by the requestor and included in the new crowd request. In this case, the new crowd engine 62 simply selects the users to attract to the new crowd at the defined POI and attracts the selected users to the new crowd at the defined POI. As yet another example, the requestor may define a list of preferred POIs for the new crowd, and the list of preferred POIs may be included in the new crowd request. The new crowd engine 62 then analyzes only the POIs in the defined list of preferred POIs, rather than all of the geographically relevant POIs, to either identify one or more potential POIs for the new crowd or automatically and programmatically select the POI for the new crowd, depending on the particular implementation.

As yet another example, while the discussion herein focuses on creating a new crowd at a single POI, the systems and processes described herein may be used to simultaneously create new crowds at multiple POIs. For instance, a requesting user may select (or the new crowd engine 62 may automatically and programmatically select) multiple POIs for a new crowd and then form multiple instances of the new crowd at the multiple POIs. Over time, the new crowd engine 62 may adjust how it is attracting users to the multiple POIs based on how well it has attracted users to those POIs thus far. So, if more users have been attracted to one of the POIs than the others, the new crowd engine 62 may then focus its attention on that POI such that users are primarily attracted to that POI to form the new crowd.

Those skilled in the art will recognize improvements and modifications to the preferred embodiments of the present disclosure. All such improvements and modifications are considered within the scope of the concepts disclosed herein and the claims that follow.

What is claimed is:

1. A method comprising:
receiving a new crowd request comprising a crowd profile for a new crowd to be formed and location information defining a geographic bounding region in which the new crowd is to be formed;
identifying one or more geographically relevant Points of Interest (POIs) that are within the geographic bounding region in which the new crowd is to be formed;
selecting a POI for the new crowd from the one or more geographically relevant POIs based on the crowd profile for the new crowd;
selecting users to attract to the new crowd at the POI selected for the new crowd based on the crowd profile for the new crowd; and
attracting the users to the new crowd at the POI selected for the new crowd.

2. The method of claim 1 wherein selecting the POI for the new crowd comprises:
identifying one or more potential POIs for the new crowd from the one or more geographically relevant POIs based on the crowd profile of the new crowd; and
receiving user input that selects the POI for the new crowd from the one or more potential POIs for the new crowd.

3. The method of claim 1 wherein selecting the POI for the new crowd comprises automatically and programmatically selecting the POI for the new crowd from the one or more geographically relevant POIs based on the crowd profile of the new crowd.

4. The method of claim 1 wherein selecting the POI for the new crowd comprises, for each geographically relevant POI of the one or more geographically relevant POIs, ranking the geographically relevant POI based on a comparison of the crowd profile of the new crowd and aggregate profiles of one or more crowds currently located at the geographically relevant POI.

5. The method of claim 4 wherein ranking the geographically relevant POI comprises ranking the geographically relevant POI based on:
the comparison of the crowd profile of the new crowd and the aggregate profiles of the one or more crowds currently located at the geographically relevant POI; and
a comparison of the crowd profile of the new crowd and aggregate profiles of one or more crowds currently located near the geographically relevant POI.

6. The method of claim 5 wherein the one or more crowds currently located near the geographically relevant POI are one or more crowds currently located within a predetermined distance from the geographically relevant POI.

7. The method of claim 1 wherein selecting the POI for the new crowd comprises, for each geographically relevant POI of the one or more geographically relevant POIs, ranking the geographically relevant POI based on a comparison of the crowd profile of the new crowd and a historical aggregate profile for the geographically relevant POI.

8. The method of claim 1 wherein selecting the POI for the new crowd comprises, for each geographically relevant POI of the one or more geographically relevant POIs, ranking the geographically relevant POI based on a comparison of the crowd profile of the new crowd and aggregate profiles of one or more crowds predicted to be located at the geographically relevant POI during a relevant time window for the new crowd.

9. The method of claim 8 wherein ranking the geographically relevant POI comprises ranking the geographically relevant POI based on:
the comparison of the crowd profile of the new crowd and the aggregate profiles of the one or more crowds predicted to be located at the geographically relevant POI during the relevant time window for the new crowd; and
a comparison of the crowd profile of the new crowd and aggregate profiles of one or more crowds predicted to be located near the geographically relevant POI during the relevant time window for the new crowd.

10. The method of claim 9 wherein the one or more crowds predicted to be located near the geographically relevant POI are one or more crowds predicted to be located within a predetermined distance from the geographically relevant POI.

11. The method of claim 1 wherein selecting the POI for the new crowd comprises, for each geographically relevant POI of the one or more geographically relevant POIs, ranking the geographically relevant POI based on a comparison of the crowd profile of the new crowd and user profiles of one or more users currently located at the geographically relevant POI.

12. The method of claim 11 wherein ranking the geographically relevant POI comprises ranking the geographically relevant POI based on:
the comparison of the crowd profile of the new crowd and the user profiles of the one or more users currently located at the geographically relevant POI; and
a comparison of the crowd profile of the new crowd and user profiles of one or more users currently located near the geographically relevant POI.

13. The method of claim 12 wherein the one or more users currently located near the geographically relevant POI are one or more users currently located within a predetermined distance from the geographically relevant POI.

14. The method of claim 1 wherein selecting the POI for the new crowd comprises, for each geographically relevant POI of the one or more geographically relevant POIs, ranking the geographically relevant POI based on a comparison of the crowd profile of the new crowd and user profiles of one or more users predicted to be located at the geographically relevant POI during a relevant time window for the new crowd.

15. The method of claim 14 wherein ranking the geographically relevant POI comprises ranking the geographically relevant POI based on:
the comparison of the crowd profile of the new crowd and the user profiles of the one or more users predicted to be located at the geographically relevant POI during the relevant time window for the new crowd; and
a comparison of the crowd profile of the new crowd and user profiles of one or more users predicted to be located near the geographically relevant POI during the relevant time window for the new crowd.

16. The method of claim 15 wherein the one or more users predicted to be located near the geographically relevant POI are one or more users predicted to be located within a predetermined distance from the geographically relevant POI.

17. The method of claim 1 wherein selecting the POI for the new crowd comprises, for each geographically relevant POI of the one or more geographically relevant POIs, ranking the geographically relevant POI based on one or more attributes defined for the new crowd.

18. The method of claim 17 wherein the one or more attributes comprises a desired crowd size for the new crowd.

19. The method of claim 1 wherein the users selected to attract to the new crowd comprise users currently located at the POI selected for the new crowd that have user profiles that sufficiently match the crowd profile of the new crowd.

20. The method of claim 1 wherein the users selected to attract to the new crowd comprise users currently located near the POI selected for the new crowd that have user profiles that sufficiently match the crowd profile of the new crowd.

21. The method of claim 1 wherein the users selected to attract to the new crowd comprise users in one or more crowds currently located at the POI selected for the new crowd that have aggregate profiles that sufficiently match the crowd profile of the new crowd.

22. The method of claim 1 wherein the users selected to attract to the new crowd comprise users in one or more crowds currently located near the POI selected for the new crowd that have aggregate profiles that sufficiently match the crowd profile of the new crowd.

23. The method of claim 1 wherein the users selected to attract to the new crowd comprise users in one or more crowds currently located at the POI selected for the new crowd that have user profiles that more closely match the crowd profile than aggregate profiles of the one or more crowds in which the users are included.

24. The method of claim 1 wherein the users selected to attract to the new crowd comprise users in one or more crowds currently located near the POI selected for the new crowd that have user profiles that more closely match the crowd profile than aggregate profiles of the one or more crowds in which the users are included.

25. The method of claim 1 wherein the users selected to attract to the new crowd comprise users currently located near the POI selected for the new crowd that have user profiles that more closely match the crowd profile of the new crowd than historical aggregate profiles for current locations of the users.

26. The method of claim 1 wherein the users selected to attract to the new crowd comprise users in one or more crowds currently located near the POI selected for the new crowd that have user profiles that more closely match the crowd profile of the new crowd than historical aggregate profiles for current locations of the crowds.

27. The method of claim 1 wherein the users selected to attract to the new crowd comprise users that left one or more crowds located at the POI selected for the new crowd within a predefined amount of time prior to the current time and have user profiles that sufficiently match the crowd profile of the new crowd.

28. The method of claim 1 wherein the users selected to attract to the new crowd comprise users that left one or more crowds located near the POI selected for the new crowd within a predefined amount of time prior to the current time and have user profiles that sufficiently match the crowd profile of the new crowd.

29. The method of claim 1 wherein the users selected to attract to the new crowd comprise users currently in one or more crowds that have historically been located at the POI selected for the new crowd and have aggregate profiles that sufficiently match the crowd profile of the new crowd.

30. The method of claim 1 wherein the users selected to attract to the new crowd comprise users currently in one or more crowds that have historically been located near the POI selected for the new crowd and have aggregate profiles that sufficiently match the crowd profile of the new crowd.

31. The method of claim 1 wherein the users selected to attract to the new crowd comprise users currently in one or more crowds predicted to be located at the POI selected for the new crowd during a relevant time window defined for the new crowd and have aggregate profiles that sufficiently match the crowd profile of the new crowd.

32. The method of claim 1 wherein the users selected to attract to the new crowd comprise users currently in one or more crowds predicted to be located near the POI selected for the new crowd during a relevant time window defined for the new crowd and have aggregate profiles that sufficiently match the crowd profile of the new crowd.

33. The method of claim 1 wherein the users selected to attract to the new crowd comprise users that have historically been located at the POI selected for the new crowd and have user profiles that sufficiently match the crowd profile of the new crowd.

34. The method of claim 1 wherein the users selected to attract to the new crowd comprise users that have historically been located near the POI selected for the new crowd and have user profiles that sufficiently match the crowd profile of the new crowd.

35. The method of claim 1 wherein the users selected to attract to the new crowd comprise users predicted to be located at the POI selected for the new crowd during a relevant time window defined for the new crowd and have user profiles that sufficiently match the crowd profile of the new crowd.

36. The method of claim 1 wherein the users selected to attract to the new crowd comprise users predicted to be located near the POI selected for the new crowd during a relevant time window defined for the new crowd and have user profiles that sufficiently match the crowd profile of the new crowd.

37. A server device comprising:
a communication interface communicatively coupling the server device to a network; and
a controller associated with the communication interface and adapted to:
receive, via the network, a new crowd request comprising a crowd profile for a new crowd to be formed and location information defining a geographic bounding region in which the new crowd is to be formed;
identify one or more geographically relevant Points of Interest (POIs) that are within the geographic bounding region in which the new crowd is to be formed;
select a POI for the new crowd from the one or more geographically relevant POIs based on the crowd profile for the new crowd;
select users to attract to the new crowd at the POI selected for the new crowd based on the crowd profile for the new crowd; and
attract the users to the new crowd at the POI selected for the new crowd.

38. A non-transitory computer-readable medium storing software comprising instructions for instructing a controller of a computing device to:
receive a new crowd request comprising a crowd profile for a new crowd to be formed and location information defining a geographic bounding region in which the new crowd is to be formed;
identify one or more geographically relevant Points of Interest (POIs) that are within the geographic bounding region in which the new crowd is to be formed;
select a POI for the new crowd from the one or more geographically relevant POIs based on the crowd profile for the new crowd;
select users to attract to the new crowd at the POI selected for the new crowd based on the crowd profile for the new crowd; and
attract the users to the new crowd at the POI selected for the new crowd.
